(19) United States
(12) Patent Application Publication
(10) Pub. No.: US 2002/0060688 A1
(43) Pub. Date: May 23, 2002

(54) Imaging apparatus

(76) Inventor: Kenji Mizumoto, Osaka-Shi (JP)

Correspondence Address: SIDLEY AUSTIN BROWN & WOOD, 717 NORTH HARWOOD, SUITE 3400, DALLAS, TX, 75201, US

(21) Appl. No.: 09/960,016

(22) Filed: Sep. 21, 2001

(30) Foreign Application Priority Data
Sep. 28, 2000 (JP) 2000-297151

(51) Int. Cl. G09G 5/02

(52) U.S. Cl. 345/591

(57) ABSTRACT

For taking an image included in whole area of the chromaticity of the visible lights by an imaging apparatus, three kinds of optical filters respectively having spectral sensitivity characteristics corresponding to color matching functions of chromaticity coordinates of new three principal colors in a new color system is used. The chromaticity coordinates of the three principal colors satisfy that a triangle formed by the three principal colors includes whole area of visible lights on a UCS chromaticity diagram, a line binding a first apex and a second apex of the triangle circumscribes at least a part of a spectral locus of the visible lights on the UCS chromaticity diagram, a line binding the second apex and a third apex of the triangle circumscribes at least a part of the spectral locus of the visible lights on the UCS chromaticity diagram, and a line binding the first apex and the third apex of the triangle circumscribes at least a part of the purple boundary on the UCS chromaticity diagram.

This application is based on patent application 2000-297151 filed in Japan, the contents of which are hereby incorporated by references.

### BACKGROUND OF THE INVENTION

1. Field of the Invention

The present invention relates to an imaging apparatus and optical filters based on a new color system expanding area of color reproduction, and an image data converting apparatus for converting color data based on the new color system to color data based on a conventional color system.

2. Description of the Related Art

Three ideal spectral sensitivity characteristics R(λ), G(λ) and B(λ), which are obtained from chromaticity of three principal colors of a picture tube and a standard white defined, for example, in the NTSC television standard, are shown in FIG. 24. As can be seen from FIG. 24, the sensitivity characteristics R(λ), G(λ) and B(λ) respectively have negative portions where the stimulus value (sensitivity) takes a negative value and positive portions where the stimulus value takes a positive value.

On the other hand, the spectral sensitivity characteristics of three principal colors in a conventional imaging apparatus such as a color television camera based on the conventional R (red), G (green) and B (blue) principal color system have characteristics substantially following the positive portions of the sensitivity characteristics R(λ), G(λ) and B(λ) shown in FIG. 24. The negative portions of the sensitivity characteristics R(λ), G(λ) and B(λ) cannot be realized, since there is no photoelectric transfer device having negative sensitivity.

A chromaticity diagram of CIE (Commission Internationale de l'Eclairage) 1931 for showing chromaticity coordinates of the three principal colors of R, G and B and the standard white defined in the NTSC television standard is shown in FIG. 25.

In FIG. 25, a curve binding the marks “◯” shows a spectrum locus of visible lights plotted at an interval of 5 nm of wavelength. In this example, the range of the visible lights is restricted from 360 nm to 800 nm. A horseshoe shaped area enclosed by the spectrum locus and the purple boundary binding both ends of the spectrum locus corresponds to the chromaticity area of the visible lights. The lines binding three apexes R, G and B for forming the triangle and an area enclosed by the lines correspond to the color reproduction area of the television. As can be seen from FIG. 25, the color reproduction area of the conventional television is smaller than the chromaticity area of the visible lights.

A UCS chromaticity diagram of CIE 1976 for showing chromaticity coordinates of the three principal colors of R, G and B of the picture tube and the standard white is shown in FIG. 26.

In the conventional imaging apparatus, the negative portion of the spectral sensitivity characteristics are omitted, so that it does not satisfy the Luther condition in the strict sense. When an image of an object is taken by the conventional imaging apparatus, the chromaticity of the object, which is included in an area in the chromaticity area of the visible lights but out of the triangle formed by the apexes of three principal colors R, G and B (hereinafter, it is abbreviated as “external chromaticity”), will be distorted so as to be compressed into the chromaticity included in the triangle. As a result, the fidelity of the image signals will be reduced. Similarly, the fidelity of the image signals with respect to the chromaticity of the object included in the triangle (hereinafter, it is abbreviated as “internal chromaticity”) will be reduced during the signal processing.

In the conventional image outputting apparatus such as a television or a color printer, the fidelity of the color reproduction between the image and the object is not so high. Furthermore, the color of the external chromaticity cannot be reproduced fundamentally, since the negative color cannot be emitted from the television.

The disadvantages that the fidelity of the image signals with respect to the chromaticity of the object in the imaging operation is lower and that the area of the color reproduction in the image outputting is smaller become no problem in the field of private demand such as amusement. On the other hand, in the field of service such as medical care or art in which a high fidelity of the image signals with respect to the chromaticity of the object and a wide area of the color reproduction are demanded, the performance of the conventional imaging apparatus or the image outputting apparatus is not sufficient. Thus, it is desired to increase the performance of the color reproduction in the imaging process and the image outputting process.

Total area of the color reproduction cannot be overpass the area of the color reproduction of the image outputting apparatus such as the television or the color printer. It, however, is significant to enlarge the area of the chromaticity of the object in the imaging operation in view of the possibility that the area of the color reproduction of the image outputting apparatus (the area of the triangle formed by three apexes of the principal colors on the chromaticity diagram) will be enlarged in the future.

Thus, it is desired to provide a new color system by which whole area of the visible lights can be imaged and the chromaticity information of the object can be converted to the image signals with high fidelity. It is further desired to provide optical filters by which the new color system can be realized and to provide an imaging apparatus based on the new color system.

When the image taken by the imaging apparatus based on the new color system is reproduced by the conventional image outputting apparatus based on the conventional color system, the color system in the imaging operation is not coincided with that in the image outputting operation, so that it is necessary to treat a predetermined converting process to the image signals taken in the imaging operation. At that time, the converting process is executed to the image data which is digitized of the image signals. Thus, it is desired to realize an image data converter by which the image data can be converted without occurrence of decolorization or pseudo-contour due to the increase of the quantization noise.

For increase the fidelity of the color reproduction, a method using a linear matrix is conventionally known. In this method, original image signals of R, G and B obtained from output signals of an imaging device is converted to new image signals of R, G and B by primary bounding the original image signals. It, however, has no effect for expanding the area of color taken by the imaging apparatus.

A principle is further utilized in a photoelectric colorimeter for enabling the imaging process of the object in the whole area of the chromaticity of the visible lights. In this principle, the spectral sensitivity characteristics of the imaging apparatus are approximated to color matching functions x(λ), y(λ) and z(λ) by using the conventional XYZ color system based on the color matching functions x(λ), y(λ) and z(λ) in which the stimulus values are set to take only the positive values. This principle, however, is not proper for increasing the fidelity of the signals with respect to the color information.

Generally, the color matching functions are designated by adding the upper bars above the symbols x, y, z and so on. In this description, the upper bars are omitted due to the typographic matter.

### SUMMERY OF THE INVENTION

A purpose of the present invention is to provide an imaging apparatus and optical filters used therein by which the color area of an image taken by the imaging apparatus can be expanded. An image including whole area of the chromaticity of the visible lights can be taken by the imaging apparatus. Furthermore, when bit number of the quantization of the image signals is considered, the distribution of the noise of quantization in the color space can be optimized by the imaging apparatus. Three kinds of optical filters respectively have different spectral transmittance characteristics, and the spectral transmittance characteristics respectively coincide with the color matching functions based on three principal colors in the above-mentioned new color system.

Another purpose of the present invention is to provide an image data converting apparatus by which signals based of the new color system outputted from the above-mentioned imaging apparatus can be converted to signals based on the conventional color system used in the conventional image outputting apparatus using the conventional color system.

An imaging apparatus in accordance with an aspect of the present invention comprises three kinds of optical filters respectively having different spectral transmittance characteristics, and a photoelectric transfer device for transferring optical images which are formed by color separation of light from an object by the optical filters to electric signals and for outputting predetermined image signals.

The spectral transmittance characteristics of the optical filters respectively correspond to color matching functions based on chromaticity coordinates of three apexes forming a triangle including whole area of visible lights on a UCS chromaticity diagram.

The chromaticity coordinates of the apexes of the triangle satisfies the following condition that a line binding a first apex and a second apex of the triangle circumscribes at least a part of a spectral locus of the visible lights on the UCS chromaticity diagram, a line binding the second apex and a third apex of the triangle circumscribes at least a part of the spectral locus of the visible lights on the UCS chromaticity diagram, and a line binding the first apex and the third apex of the triangle circumscribes at least a part of the purple boundary on the UCS chromaticity diagram.

By such a configuration, the three optical filters can have the spectral transmittance characteristics corresponding to the color matching functions when the chromaticity coordinates of the apexes of the triangle including the whole area of the visible lights on the UCS chromaticity diagram are used as the chromaticity coordinates of three principal colors in the new color system. Since the color matching functions of the new three principal colors take only zero or the positive value, no photoelectric transfer device having negative sensitivity will be necessary for realizing the spectral sensitivity characteristics corresponding to the color matching functions. As a result, all the colors of the object can be taken by the imaging apparatus, and the color area of the imaging apparatus can be expanded.

Furthermore, since the chromaticity coordinates of the apexes of the triangle satisfy the above-mentioned conditions, a ratio of the area of the visible lights with respect to the area of the triangle formed by the three apexes can be made as larger as possible, and the area of the triangle can be utilized effectively. Thus, a color space having a high efficiency of the data can be realized.

An image data converting apparatus in accordance with an aspect of the present invention further comprises a color system converter for converting three image signals outputted from the photoelectric transfer device based on the above-mentioned new color system to predetermined image signals based on a conventional color system using the known three principal colors.

By such a configuration, the image signals taken by the above-mentioned imaging apparatus based on the new color system can be converted to the image signals based on the conventional color system, so that the image can be outputted by the conventional image outputting apparatus.

### BRIEF DESCRIPTION OF THE DRAWINGS

FIG. 1 is a block diagram for showing a configuration of an embodiment of an imaging apparatus in accordance with the present invention;

FIG. 2 is a u′v′ chromaticity diagram for showing a first example of a new color system based on new three principal colors in accordance with the present invention;

FIG. 3 is a graph for showing color matching functions in the first example of the new color system;

FIG. 4 is a u′v′ chromaticity diagram for showing an example of the quantization of the chromaticity values in the first example of the new color system;

FIG. 5 is a u′v′ chromaticity diagram for showing another example Of the quantization of the chromaticity values in the first example of the new color system;

FIG. 6 is a u′v′ chromaticity diagram for showing still another example of the quantization of the chromaticity values in the first example of the new color system;

FIG. 7 is a u′v′ chromaticity diagram for showing a second example of a new color system satisfying a condition “A2” and based on new three principal colors in accordance with the present invention;

FIG. 8 is a graph for showing color matching functions in the second example of the new color system satisfying the condition “A2”;

FIG. 9 is a u′v′ chromaticity diagram for showing the second example of a new color system satisfying a condition “B2” and based on new three principal colors in accordance with the present invention;

FIG. 10 is a graph for showing color matching functions in the second example of the new color system satisfying the condition “B2”;

FIG. 11 is a u′v′ chromaticity diagram for showing the second example of a new color system satisfying a condition “C2” and based on new three principal colors in accordance with the present invention;

FIG. 12 is a graph for showing color matching functions in the second example of the new color system satisfying the condition “C2”;

FIG. 13 is a uv chromaticity diagram for showing a third example of a new color system based on new three principal colors in accordance with the present invention;

FIG. 14 is a graph for showing color matching functions in the third example of the new color system;

FIG. 15 is a uv chromaticity diagram for showing a fourth example of a new color system satisfying a condition “C4” and based on new three principal colors in accordance with the present invention;

FIG. 16 is a graph for showing color matching functions in the second example of the new color system satisfying the condition “C4”;

FIG. 17 is a uv chromaticity diagram for showing the fourth example of a new color system satisfying a condition “D4” and based on new three principal colors in accordance with the present invention;

FIG. 18 is a graph for showing color matching functions in the second example of the new color system satisfying the condition “D4”;

FIG. 19 is a block diagram for showing a first example of an electric configuration of the image data converting apparatus in accordance with the present invention;

FIG. 20 is a u′v′ chromaticity diagram for showing an image data converting processing in the first example of the image data converting apparatus;

FIG. 21 is a block diagram for showing a second example of an electric configuration of the image data converting apparatus in accordance with the present invention;

FIG. 22 is a u′v′ chromaticity diagram for showing an image data converting processing in the second example of the image data converting apparatus;

FIG. 23 is a u′v′ chromaticity diagram for showing another converting characteristic of a color system converter in the second example of the image data converting apparatus;

FIG. 24 is the graph for showing the ideal spectral sensitivity characteristics R(λ), G(λ) and B(λ) in the conventional NTSC television standard;

FIG. 25 is the CIE 1931 chromaticity diagram for showing the chromaticity coordinates of the three principal colors R, G and B and the standard white defined in the NTSC television standard; and

FIG. 26 is the CIE 1976 UCS chromaticity diagram for showing the chromaticity coordinates of the three principal colors R, G and B and the standard white.

### DETAILED DESCRIPTION OF THE EMBODIMENT

### Imaging Apparatus and Optical Filters

An embodiment of an imaging apparatus and optical filters in accordance with the present invention is described.

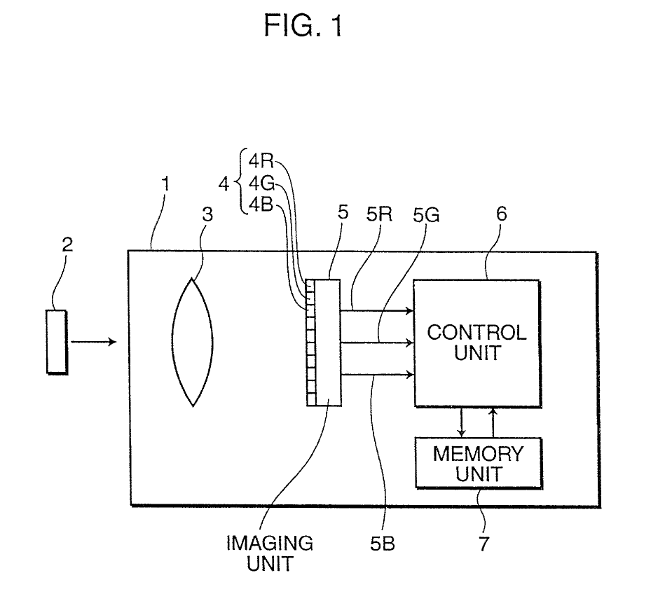

A schematic configuration of an imaging apparatus in the embodiment is shown in FIG. 1. The imaging apparatus 1 for taking a color image of an object 2 comprises a taking lens 3, a set of optical filters 4, an imaging unit 5, a control unit 6 and a memory unit 7.

The taking lens 3 focuses an image of the object 2 on a light receiving surface of the imaging unit 5. The optical filters 4 comprises a plurality of optical filters 4R, 4G and 4B which are arranged as a predetermined pattern. The imaging unit 5 includes am area sensor in which a plurality of photoelectric transfer devices are arranged two-dimensionally, and any of the optical filters 4R, 4G and 4B is disposed in front of each photoelectric transfer device. The optical filters 4 and the imaging unit 5 are integrally configured. The optical filters 4R, 4G and 4B respectively have different spectral transmittance characteristics. The photoelectric transfer devices of the imaging unit 5 respectively transfer the optical energy of the image to electric signals and outputs the electric signals as the color image signals 5R, 5G and 5B.

The control unit 6 includes a CPU (Central Processing Unit) for executing predetermined operation programs. The memory unit 7 includes a ROM (Read Only Memory) for memorizing the operation programs and a RAM (Random Access Memory) temporarily for memorizing control data and so on. The control unit 6 memorizes the image signals outputted from the imaging unit 5 into the memory unit 7 and processes a predetermined image process to the image signals by following the control program memorized in the memory unit 7.

Subsequently, the spectral sensitivity characteristics of the optical filters 4R, 4G and 4B are described.

In the color reproduction system of the conventional television standard, chromaticity values of three principal colors and a standard white emitted from the television are decided. After that, the ideal spectral sensitivity characteristics of the color TV (video) camera are obtained.

On the other hand, in the imaging apparatus in this embodiment, three principal colors which can include imaginary colors are newly proposed, which will be used in the imaging operation, with no relation to the actual three principal colors of the image outputting apparatus such as the television. Concretely, the new principal colors are selected on the CIE 1976 UCS chromaticity diagram (u′v′ chromaticity diagram) or the CIE 1960 UCS chromaticity diagram (uv chromaticity diagram). The optical filters 4R, 4G and 4B are formed in a manner so that the spectral sensitivity characteristics of the optical filters correspond to the color matching functions of the new principal colors in the new color system.

The above-mentioned UCS chromaticity diagrams is graduated so that the sensory difference between two different colors having the same brightness will be substantially in proportion to the geometrical distance between the coordinates of the colors on the diagram.

### First Example of New Color System

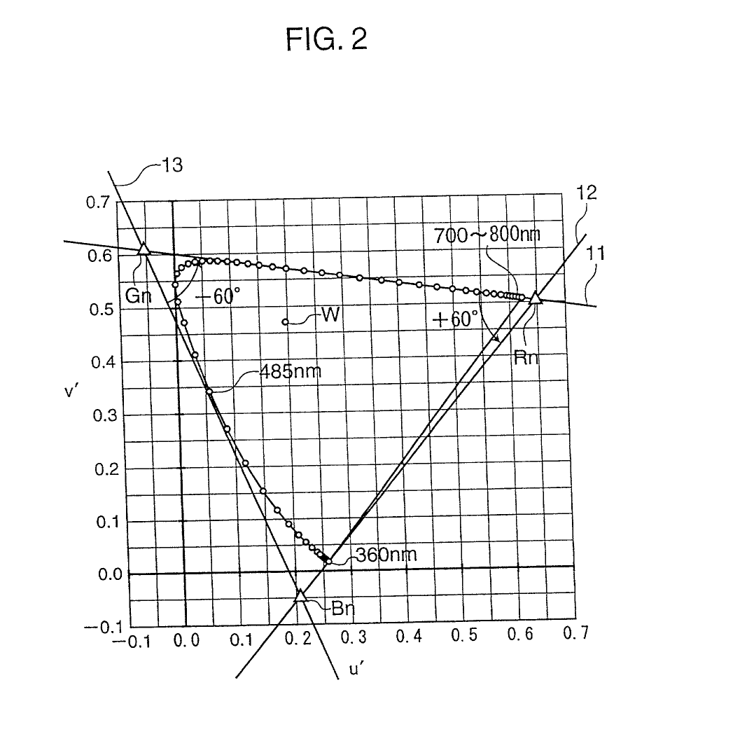

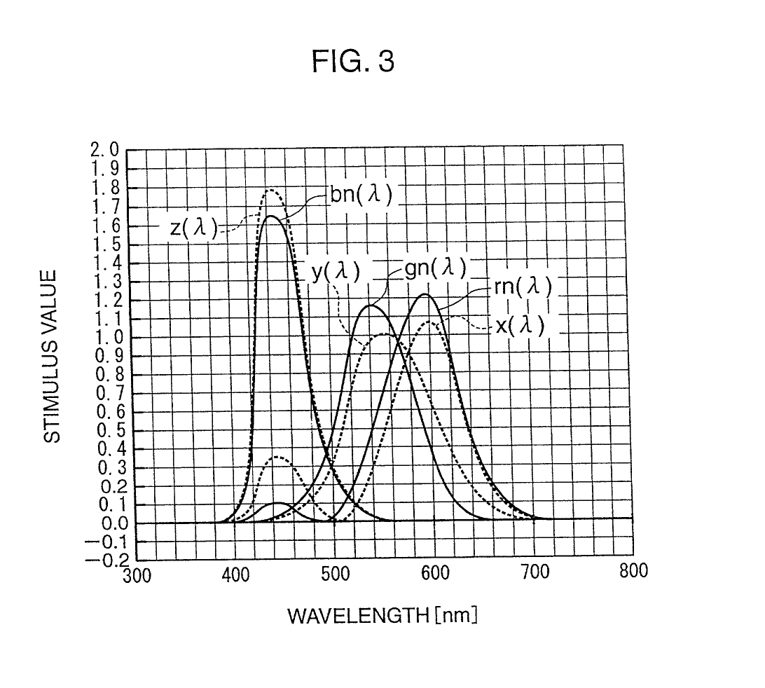

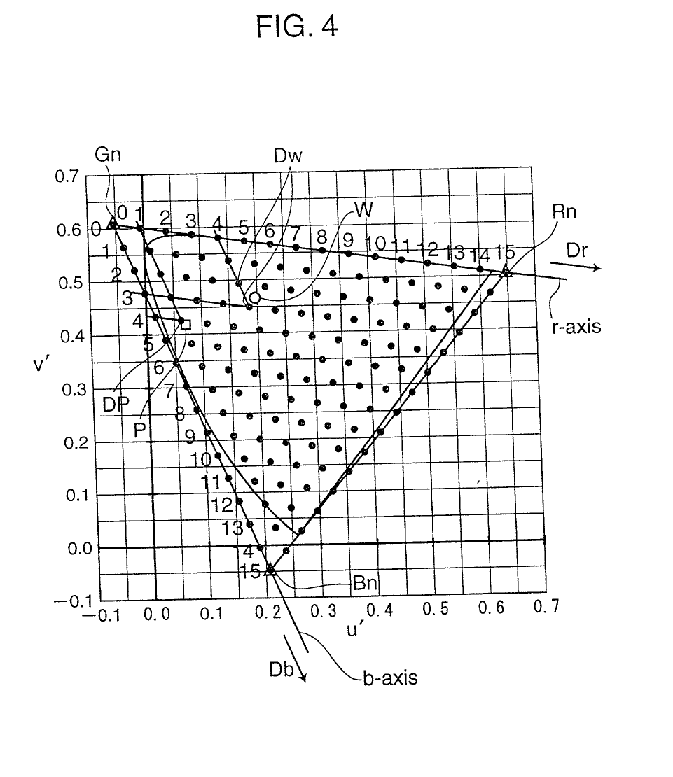

Subsequently, a first example of the new color system in the embodiment in accordance with the present invention will be described. FIG. 2 shows a u′v′ chromaticity diagram of the first example of the new color system. FIG. 3 shows color matching functions of the first example of the new color system based on new three principal colors. FIGS. 4 to 6 respectively show u′v′ chromaticity diagrams for explaining quantized chromaticity coordinates.

In the first example, the chromaticity coordinates of the new principal colors Rn, Gn and Bn (apexes of a triangle) are selected on the u′v′ chromaticity diagram so as to satisfy the following five conditions.

A first condition is that the chromaticity of the visible lights is completely included inside the triangle or disposed on the sides of the triangle formed by the new principal colors Rn, Gn and Bn.

A second condition is that the apexes of Rn and Gn are disposed on a line on the u′v′ chromaticity diagram corresponding to x+y=1 on the CIE 1931 chromaticity diagram (xy chromaticity diagram).

A third condition is that a line binding the apexes of Gn and Bn circumscribes the spectral locus of the visible lights.

A fourth condition is that a line binding the apexes of Rn and Bn circumscribes a part (in a shorter wavelength portion) of the purple boundary which corresponds to a line binding the chromaticity points of the longest wavelength and the shortest wavelength on the spectral locus of the visible lights.

A fifth condition is that the triangle formed by the apexes of Rn, Gn and Bn is the equilateral triangle.

When the first condition is satisfied, the color matching functions obtained from the new principal colors can take only zero or the positive value. Thus, no photoelectric transfer device having negative sensitivity will be necessary for realizing the spectral sensitivities corresponding to the color matching functions, so that all colors in the visible lights can be recorded by the imaging apparatus using the new color system.

When the second, third and fourth conditions are satisfied, a ratio of the area of the visible lights with respect to the area of the triangle formed by the three apexes of the new principal colors can be made as larger as possible, and the area of the triangle can be utilized effectively. In other words, the ratio of the combination of the signals actually used with respect to the total number 2³^{ₙ} of the combination of the signal data defined by the bit number “n” of the quantization of the principal color signals in the new color system becomes higher. The same rule can be applied to quantize the chromaticity signals, so that a color space having a high efficiency of the data utility can be realized, entirely.

When the fourth condition is satisfied, the principal color Gn cannot concern in the shorter wavelength portion on the chromaticity diagram. In other words, the color matching function of the principal color Gn gradually reduces in the shorter wavelength portion. The color in the shorter wavelength portion is designated only by the principal colors Rn and Bn, so that the color matching function Gn(λ) becomes a curve having a few inflection points. As a result, it becomes easier to manufacture the optical filter 4G having a spectral sensitivity characteristic substantially coinciding with that of the color matching function Gn(λ).

When the fifth condition is satisfied, the chromaticity points which are the quantization of the chromaticity information of the object will be distributed uniformly in the two-dimensional space on the u′v′ chromaticity diagram. Details of this will be described after.

Steps for setting the chromaticity coordinates of the new principal colors Rn, Gn and Bn satisfying the above-mentioned first to fifth conditions are described. The interior angles at the apexes Rn, Gn and Bn of the triangle formed by the new principal colors Rn, Gn and Bn are shown as ∠R, ∠G and ∠B.

In FIG. 2, the marks “◯” on the spectral locus of the visible lights designate the spectral stimulus at an interval by 5 nm of wavelength, and the range of the wavelengths of the visible lights is selected from about 360 nm to about 800 nm. A first straight line 11 satisfies a condition 0.15u′+v′=0.6 which corresponds to a line satisfying x+y=1 on the xy chromaticity diagram. A second straight line 12 crosses the first straight line 11 at an angle +60 degrees and circumscribes a part of the purple boundary. A third straight line 13 crosses the first straight line 11 at an angle −60 degrees and circumscribes a part of the spectral locus.

The crossing point of the first and second straight lines 11 and 12 is selected as the apex Rn. The crossing point of the first and third straight lines 11 and 13 is selected as the apex Gn. The crossing point of the second and third straight lines 12 and 13 is selected as the apex Bn. By such a configuration, the interior angles ∠R=∠G=∠B=60 degrees. By selecting these chromaticity coordinates of the new principal colors Rn, Gn and Bn, the above-mentioned first to fifth conditions are satisfied.

A side RnGn binding the apexes Rn and Gn of the equilateral triangle circumscribes the spectral locus in a region of the wavelength 700 nm to 800 nm. A side GnBn binding the apexes Gn and Bn of the equilateral triangle circumscribes the spectral locus at a point about 485 nm. A side RnBn binding the apexes Rn and Bn of the equilateral triangle circumscribes the purple boundary at a point about 360 nm.

The chromaticity coordinates of the new principal colors Rn, Gn, Bn and a standard white are shown in the following table 1. In the first example, the standard light D65 by CIE is selected as the standard white.

TABLE 1

| | x | Y | u′ | v′ |
|---|---|---|---|---|
| Rn | 0.7427 | 0.2573 | 0.6456 | 0.5032 |
| Gn | −0.2391 | 1.2391 | −0.0521 | 0.6078 |
| Bn | 0.1323 | −0.0139 | 0.2061 | −0.0487 |
| W (D65) | 0.31277 | 0.32910 | 0.19785 | 0.46838 |

Hereupon, the relations between the chromaticity coordinates x, y and the spectral tristimulus values X, Y and Z in the CIE 1931 color system is shown by the following equations (1) and (2).

x=X/(X+Y+Z) (1)

y=Y/(X+Y+Z) (2)

The relations between the chromaticity coordinates u′ and v′ on the u′v′ chromaticity diagram and the spectral tristimulus values X, Y and Z in the CIE 1931 color system is shown by the following equations (3) and (4).

u′=4X/(X+15Y+3Z) (3)

v′=9Y/(X+15Y+3Z) (4)

As a relation between the tristimulus values Rn, Gn and Bn in the new color system and the spectral tristimulus values X, Y and Z. the following equation (5) or (6) can be obtained from the above-mentioned table 1 and the equations (1) and (2).

$$\begin{matrix}( \begin{matrix}X \\ Y \\ Z\end{matrix} ) = ( \begin{matrix}0.9217 & - 0.1347 & 0.1634 \\ 0.3193 & 0.6979 & - 0.0172 \\ 0.0000 & 0.0000 & 1.0882\end{matrix} ) ( \begin{matrix}Rn \\ Gn \\ Bn\end{matrix} ) & ( 5 ) \\ ( \begin{matrix}Rn \\ Gn \\ Bn\end{matrix} ) = ( \begin{matrix}1.0169 & 0.1962 & - 0.1496 \\ - 0.4652 & 1.3431 & 0.0910 \\ 0.0000 & 0.0000 & 0.9189\end{matrix} ) ( \begin{matrix}X \\ Y \\ Z\end{matrix} ) & ( 6 )\end{matrix}$$

Hereupon, 0≦=Rn, Gn and Bn≦1. The maximum value of the stimulus value Y when the stimulus values Rn=Gn=Bn=1 is standardized to be “1”.

The color matching functions rn(λ), gn(λ) and bn(λ) shown in FIG. 3 is obtained from the color matching functions x(λ), y(λ) and z(λ) in the XYZ color system and the above-mentioned equation (6).

The following equations (7) and (8) showing the relations between the u′v′ chromaticity coordinates and the stimulus values Rn, Gn and Bn in the new color system can be obtained from the equations (3), (4) and (5).

u′=(3.6870Rn−0.5387Gn+0.6534Bn)/(5.7109Rn+10.3337Gn+3.1704Bn) (7)

v′=(2.8735Rn+6.2810Gn−0.1546Bn)/(5.7109Rn+10.3337Gn+3.1704Bn) (8)

When the denominator of the above-mentioned equation (7) or (8) is used as a sum of the stimulus values S in the stimulus values Rn, Gn and Bn, the chromaticity coordinates r, g and b can be shown as following equations (9) to (11).

r=L·Rn/S (9)

g=M·Gn/S (10)

b=N·Bn/S (11)

r+g+b=1 (12)

L=5.7109, M=10.3337, N=3.1704 (13)

S=L·Rn+M·Gn+N·Bn (14)

0≦r, g, b≦1

When the equations (7) and (8) are compared with the equations (9) to (11), the numerators of the chromaticity coordinates r, g and b in the equations (9) to (11) are simplified from those in the u′v′ chromaticity coordinates, so that the calculation of the chromaticity coordinates can be made faster by using the chromaticity coordinates r, g and b.

When the chromaticity coordinates r, g and b are quantized, the chromaticity data Dr, Dg and Db which are digital data can be obtained. The following equation (15) holds good for the chromaticity data Dr, Dg and Db. Hereupon the symbol “n” designates the bit number of the quantization.

Dr+Dg+Db=2ⁿ−1 (15)

In the two-dimensional space of the chromaticity coordinates, it is possible to point the position of the coordinate by using only two values among the three quantized values. For example, the coordinates shown by using the chromaticity data Dr and Db are described with reference to FIG. 4. As can be seen from FIG. 4, the chromaticity data of the new principal colors Rn, Gn and Bn are shown as Rn(15, 0), Gn(0, 0) and Bn(0, 15).

The marks “●” designate the positions (quantization points) of the chromaticity data Dr and Db on the u′v′ chromaticity diagram. In this example, the bit number of the quantization “n” is selected to be “4” (n=4). The marks “●” are disposed at a predetermined interval along r-axis and b-axis crossing at the chromaticity coordinate Gn serving as the origin. A distance between adjoining two quantization points is made the same in any direction. In other words, the quantization points are arranged at apexes of the equilateral triangles. As a result, the chromaticity data of the object taken by the imaging apparatus can be quantized two-dimensionally on the u′v′ chromaticity diagram, uniformly.

Since the u′v′ chromaticity diagram is graduated so that the sensory difference between two different colors having the same brightness will be substantially in proportion two the geometrical distance between the coordinates of the colors on the diagram at any point on the diagram, the noise of the quantized chromaticity with respect to the bit number of the quantization can be made the smallest by quantizing the u′v′ chromaticity diagram, uniformly. The chromaticity data can be regarded as perception value.

The uniformity of the quantization points on the u′v′ chromaticity diagram is defined by the denominator (sum of the stimulus values S) in the equations (9) to (11). The directions of the quantization, that is, the quantization axes are defined by the factor of the numerators in the equations (9) to (11). In the first example, the triangle formed by the new principal colors is the equilateral triangle, so that the distance between the adjoining two quantization points becomes the same in any direction when the bit number “n” of the quantization of the r-axis is made the same as that of the b-axis. When the three sides of the triangle are regarded as the quantization axes, the chromaticity points corresponding to the quantized chromaticity coordinates are uniformly distributed in all the quantization axes on the u′v′ chromaticity diagram, and the graduation pitches on the quantization axes become the same.

Chromaticity indication of the image signals in the first example is concretely described. For example, the color image signals Rn=0.1, Gn=0.5 and Bn=0.7 are outputted from the imaging unit 5 of the imaging apparatus 1 shown in FIG. 1. The coordinates P(u′, v′)=P(0.0700, 0.4172) are obtained from the equations (7) and (8). Furthermore, the chromaticity coordinates r=0.0718, g=0.6493 and b=0.2789 are obtained from the equations (9) to (11). When the chromaticity coordinates r, g and b are quantized, the chromaticity data Dr, Dg and Db are obtained as follows. Hereupon, the symbol “int” designates an integer of the calculated result in the parenthesis by the round off.

Dr=int(0.0718·(2⁴−1))=1

Dg=int(0.6493·(2⁴−1))=10

Db=int(0.2789·(2⁴−1))=4

This coordinate corresponds to a point Dp(1, 4) which is substantially the same position as the above-mentioned point “P”.

The coordinate of the standard white W on the u′v′ chromaticity diagram becomes W(u′, v′)=W(0.1979, 0.4684) from the above-mentioned table 1. Thus, the chromaticity coordinates r=0.2979, g=0.5367 and b=0.1654 are obtained from the equations (9) to (11). When the chromaticity coordinates r, g and b are quantized, the chromaticity data Dr, Dg and Db are obtained as follows.

Dr=int(0.2979·(2⁴−1))=4

Dg=int(0.5367·(2⁴−1))=8

Db=int(0.1654·(2⁴−1))=2

This coordinate corresponds to a point Dw(4, 2).

In this example, the sum of the quantized values becomes 14 owing to the round off. It is possible to compensate the coordinate of the point Dw(4, 3) by adding a value “1” to the smallest chromaticity data Db to be Db=3 for satisfying the equation (15). Even when any of the point Dw(4. 2) and Dw(4, 3) is adopted, the point Dw is disposed in the vicinity of the point W in FIG. 4.

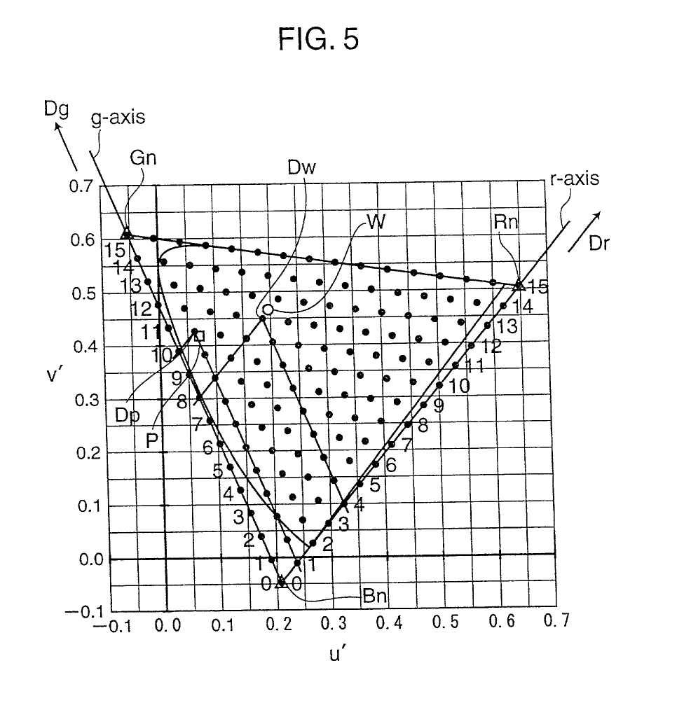

Subsequently, the coordinates shown by using the chromaticity data Dr and Dg are described with reference to FIG. 5. In this case, it is possible to point the coordinate corresponding to the chromaticity data along the r-axis passing the apex Rn and the g-axis passing the apex Gn when the apex Bn is used as the origin. The points Dp(1, 10) and Dw(4, 8) in FIG. 5 are illustrated at the same points as those in FIG. 4.

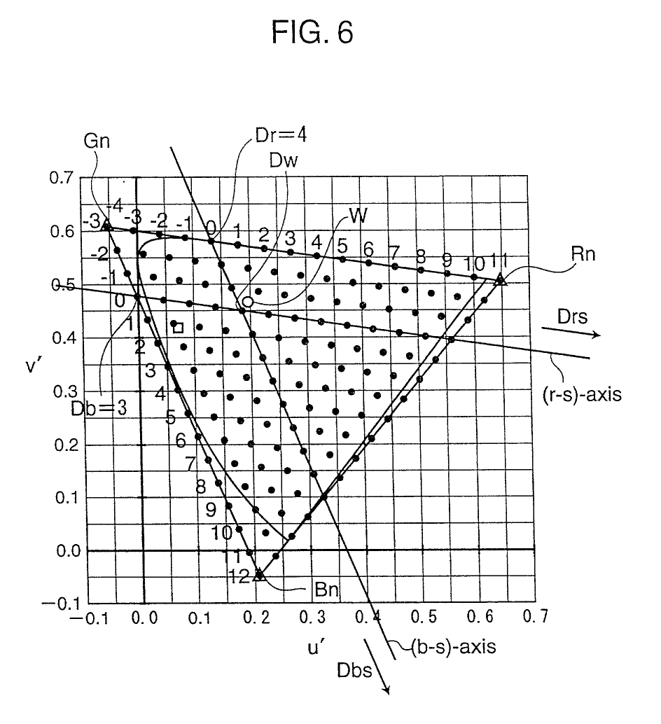

Another example of the axes of the coordinate in which the point corresponding to the standard white is used as the origin is described with reference to FIG. 6. In FIG. 6, the chromaticity data Dw is used as the origin under the condition that the chromaticity data Dr and Db are used. In comparison with FIGS. 4 and 6, the r-axis and the b-axis are shifted to an (r-s) axis and a (b-s) axis in parallel, and the point Dw(4, 3) is used as the new origin. In this example, the coordinate values Drs and Dbs are shown as Drs=Dr−4 and Dbs=Db−3.

By setting the new axes of the coordinate with respect to the standard white serving as the origin, the information with respect to the chromaticity can be considered in terms of the hue and the saturation. In this case, it is possible to notate the chromaticity information as a quantity of color difference.

Still another example for notating the factor of the numerators in the equations (9) to ( 11) as the color difference quantities is described. In this example, it is generally impossible to realize the two-dimensional uniform distribution of the quantization points, except the case when the chromaticity point of the standard white is disposed at the center of gravity of the equilateral triangle. The distribution of the quantization points will be uniform along the quantization axes. It, however, is possible to consider the chromaticity information in terms of the hue and the saturation by notating the chromaticity information as the color difference quantities.

When the stimulus values Rn, Gn and Bn in the new color system in the equations (9) to (11) are replaced by Rn-Gn, Gn-Bn and Bn-Rn, the axes of the coordinate rg, gb and br are obtained as following equations (16) to (18).

rg=L·M/(L+M)·(Rn−Gn)/S (16)

gb=M·N/(M+N)·(Gn−Bn)/S (17)

br=N·L/(N+L)·(Bn−Rn)/S (18)

Since the widths of the values of the equations (16) to (18) are standardized to be “1”, the chromaticity data Drg, Dgb and Dbr can be obtained by quantizing the respective values.

By following the above-mentioned procedure, the chromaticity coordinate of a part of the object 2 taken by the imaging apparatus 1 can be obtained. Thus, the chromaticity information of whole the image of the object can be obtained by repeating the above-mentioned processes with respect to the whole of the image of the object 2.

In the first example mentioned above, the range of wavelengths of the visible lights is selected from 360 nm to 800 nm. It is possible to use the range from 400 nm to 700 nm which is generally used as the range of the visible lights.

Table 2 shows the chromaticity coordinates of the new principal colors Rn, Gn and Bn and the standard white in the latter case. Similarly, the standard light D65 by CIE is selected as the standard white.

TABLE 2

| | x | y | u′ | v′ |
|---|---|---|---|---|
| Rn | 0.7421 | 0.2579 | 0.6440 | 0.5034 |
| Gn | −0.2391 | 1.2391 | −0.0521 | 0.6078 |
| Bn | 0.1322 | −0.0135 | 0.2055 | −0.0472 |
| W (D65) | 0.31277 | 0.32910 | 0.19785 | 0.46838 |

As a relation between the tristimulus values Rn, Gn and Bn in the new color system and the spectral tristimulus values X, Y and Z, the following equation (19) or (20) can be obtained from the above-mentioned table 2 and the equations (1) and (2). Hereupon, 0≦Rn, Gn and Bn≦1.

$$\begin{matrix}( \begin{matrix}X \\ Y \\ Z\end{matrix} ) = ( \begin{matrix}0.9216 & - 0.1344 & 0.1633 \\ 0.3202 & 0.6965 & - 0.0167 \\ 0.0000 & 0.0000 & 1.0882\end{matrix} ) ( \begin{matrix}Rn \\ Gn \\ Bn\end{matrix} ) & ( 19 ) \\ ( \begin{matrix}Rn \\ Gn \\ Bn\end{matrix} ) = ( \begin{matrix}1.0169 & 0.1962 & - 0.1496 \\ - 0.4675 & 1.3456 & 0.0907 \\ 0.0000 & 0.0000 & 0.9189\end{matrix} ) ( \begin{matrix}X \\ Y \\ Z\end{matrix} ) & ( 20 )\end{matrix}$$

The color matching functions rn(λ), gn(λ) and bn(λ) shown in FIG. 3 is obtained from the color matching functions x(λ), y(λ) and z(λ) in the XYZ color system and the above-mentioned equation (20).

The following equations (21) and (22) showing the relations between the u′v′ chromaticity coordinates and the stimulus values Rn, Gn and Bn in the new color system can be obtained from the equations (3), (4) and (19).

u′=(3.6862Rn−0.5376Gn+0.6530Bn)/(5.7243Rn+10.3129Gn+3.1779Bn) (21)

v′=(2.8817Rn+6.2684Gn−0.1500Bn)/(5.7243Rn+10.3129Gn+3.1779Bn) (22)

When the denominator of the above-mentioned equation (21) or (22) is used as a sum of the stimulus values S in the stimulus values Rn, Gn and Bn, the chromaticity coordinates r, g and b can be shown as the same manner as the above-mentioned equations (9) to (11).

L=5.7243, M=10.3129, N=3.1779 (23)

S=L·Rn+M·Gn+N·Bn (24)

0≦r, g, b≦1

When the range from 400 nm to 700 nm is used as the range of the visible lights, a negative value occurs in the color matching function Rn(λ) with respect to the principal color Rn. It, however, is no problem, since the negative value is very small.

### Second Example of New Color System

In the above-mentioned first example of the new color system, the triangle formed by the new principal colors is to be the equilateral triangle, so that the distance between the adjoining two quantization points becomes the same in any direction.

In the second example which will be described below, the triangle formed by the new principal colors is not to be the equilateral triangle, so that the distance between the adjoining two quantization points becomes the same with respect to a direction parallel to a predetermined quantization axis.

In the second example, the chromaticity coordinates (apexes of triangle) of the new principal colors Rn, Gn and Bn are selected on the u′v′ chromaticity diagram so as to satisfy the following four conditions.

A first condition is that all the chromaticity of the visible lights is included in a triangle or disposed on the sides of the triangle formed by the new principal colors Rn, Gn and Bn.

A second condition is that the apexes of Rn and Gn are disposed on a line on the u′v′ chromaticity diagram corresponding to x+y=1 on the xy chromaticity diagram.

A third condition is that a line binding the apexes of Gn and Bn circumscribes the spectral locus of the visible lights.

A fourth condition is that a line binding the apexes of Rn and Bn superimposes on the purple boundary.

The first to third conditions are the same as those in the first example, so that the same effect can be obtained by satisfying the conditions.

In the second example, the apex Rn of the triangle is selected to be the longest wavelength of the visible lights is set to be 800 nm on the u′v′ chromaticity diagram. Since the apex Rn becomes the crossing point of the purple boundary and the line 0.15u′+v′=0.6 corresponding to the line x+y=1 on the xy chromaticity diagram, by satisfying the above-mentioned third and fourth conditions. Thus, the interior angle ∠R≈61.8 degrees. Instead of the fifth condition in the above-mentioned first example, any one of the following four conditions “A2” to “D2” is satisfied.

The condition “A2” is that the triangle formed by the new principal colors Rn, Gn and Bn is an isosceles triangle in which the interior angle ∠R with respect to the apex Rn is 61.8 degrees (∠R=61.8 degrees), and the other interior angles ∠G and ∠B with respect to the apexes Gn and Bn are to be 59.1 degrees (∠G=∠B=(180−61.8)/2=59.1 degrees).

The condition “B2” is that the triangle formed by the new principal colors Rn, Gn and Bn is an isosceles triangle in which the interior angles ∠R and ∠B with respect to the apexes Rn and Bn are to be 61.8 degrees (∠R=∠B=61.8 degrees), and the other interior angle ∠G with respect to the apex Gn is 56.4 degrees (∠G=(180−61.8×2)=56.4 degrees).

The condition “C2” is that the triangle formed by the new principal colors Rn, Gn and Bn is an isosceles triangle in which the interior angles ∠R and ∠G with respect to the apexes Rn and Gn are to be 61.8 degrees (∠R=∠G=61.8 degrees), and the other interior angle ∠B with respect to the apex Bn is 56.4 degrees (∠B=(180−61.8×2)=56.4 degrees).

The condition “D2” is that the triangle formed by the new principal colors Rn, Gn and Bn is a triangle in which the interior angle ∠R with respect to the apex Rn is 61.8 degrees (∠R=61.8 degrees), and the other interior angles ∠G and ∠B with respect to the apexes Gn and Bn satisfy the equation of ∠G+∠B=180−61.8=118.2 degrees.

When the triangle formed by the new principal colors Rn, Gn and Bn is made to be the isosceles triangle by satisfying one of the conditions “A2” to “C2”, the quantization points are uniformly distributed along the quantization axes on the u′v′ chromaticity diagram, and the isosceles two axes have the same gradation pitch. On the other hand, when the triangle formed by the new principal colors Rn, Gn and Bn is made not to be the isosceles triangle by satisfying the condition “D2”, the quantization points are uniformly distributed along respective three quantization axes on the u′v′ chromaticity diagram.

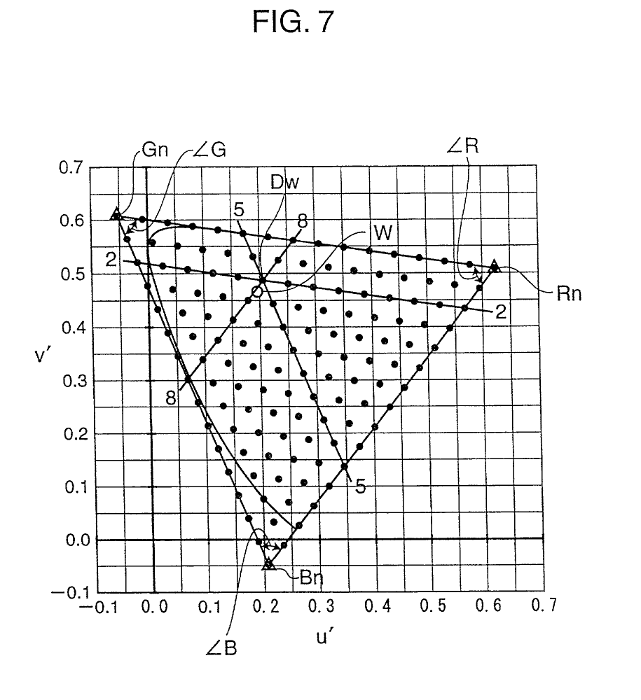

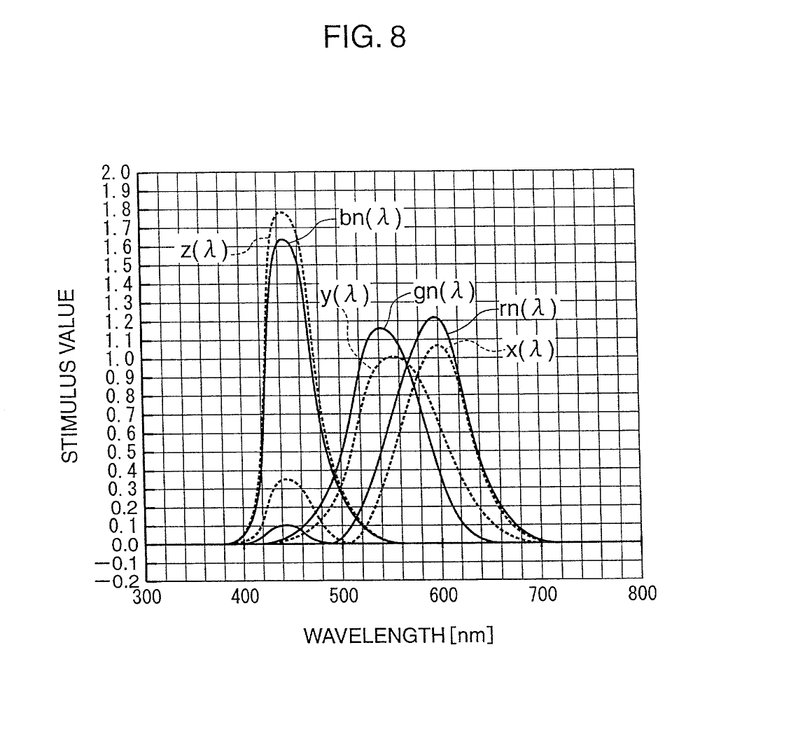

FIG. 7 shows the u′v′ chromaticity diagram in the second example of the new color system satisfying the condition “A2”. FIG. 8 shows the color matching functions of the new color system based on the new principal colors satisfying the above-mentioned condition “A2”. The line GnBn binding the apexes Gn and Bn circumscribed the spectral locus at a point about 485 nm.

The chromaticity coordinates of the new principal colors Rn, Gn, Bn and the standard white (D65) are shown in the following table 3.

TABLE 3

| | x | y | u′ | v′ |
|---|---|---|---|---|
| Rn | 0.7347 | 0.2653 | 0.6234 | 0.5065 |
| Gn | −0.2692 | 1.2692 | −0.0574 | 0.6086 |
| Bn | 0.1363 | −0.0130 | 0.2120 | −0.0454 |
| W (D65) | 0.31277 | 0.32910 | 0.19785 | 0.46838 |

As a relation between the stimulus values Rn, Gn and Bn in the new color system and the spectral tristimulus values X, Y and Z, the following equation (25) or (26) can be obtained from the above-mentioned table 3 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}0.9258 & - 0.1446 & 0.1692 \\ 0.3343 & 0.6818 & - 0.0161 \\ 0.0000 & 0.0000 & 1.0882\end{matrix} ) ( \begin{matrix}Rn \\ Gn \\ Bn\end{matrix} ) & ( 25 ) \\ ( \begin{matrix}Rn \\ Gn \\ Bn\end{matrix} ) = ( \begin{matrix}1.0033 & 0.2128 & - 0.1528 \\ - 0.4920 & 1.3624 & 0.0966 \\ 0.0000 & 0.0000 & 0.9189\end{matrix} ) ( \begin{matrix}X \\ Y \\ Z\end{matrix} ) & ( 26 )\end{matrix}$$

The color matching functions rn(λ), gn(λ) and bn(λ) shown in FIG. 8 is obtained from the color matching functions x(λ), y(λ) and z(λ) in the XYZ color system and the above-mentioned equation (26).

The following equations (27) and (28) showing the relations between the u′v′ chromaticity coordinates and the stimulus values Rn, Gn and Bn in the new color system can be obtained from the equations (3), (4) and (25).

u′=(3.7033Rn−0.5784Gn+0.6767Bn)/(5.9049Rn+10.0819Gn+3.1923Bn) (27)

v′=(3.0090Rn+6.1359Gn−0.1449Bn)/(5.9049Rn+10.0819Gn+3.1923Bn) (28)

Similar to the first example, by replacing the numerals to the following symbols

L=5.9049, M=10.0819, and N=3.1923 (29),

the chromaticity data Dr, Dg and Db can be obtained. The chromaticity data Dw of the standard white W becomes that Dw(Dr, Dg, Db)=Dw(5, 8, 2) as shown in FIG. 7.

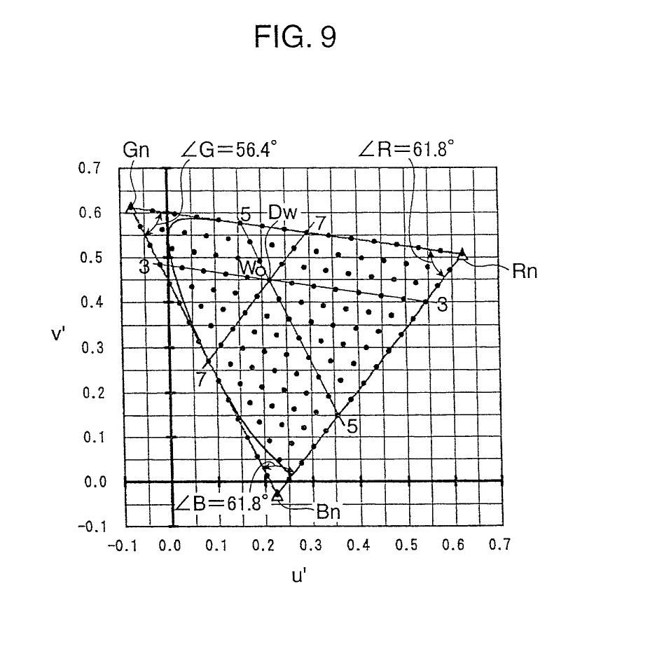

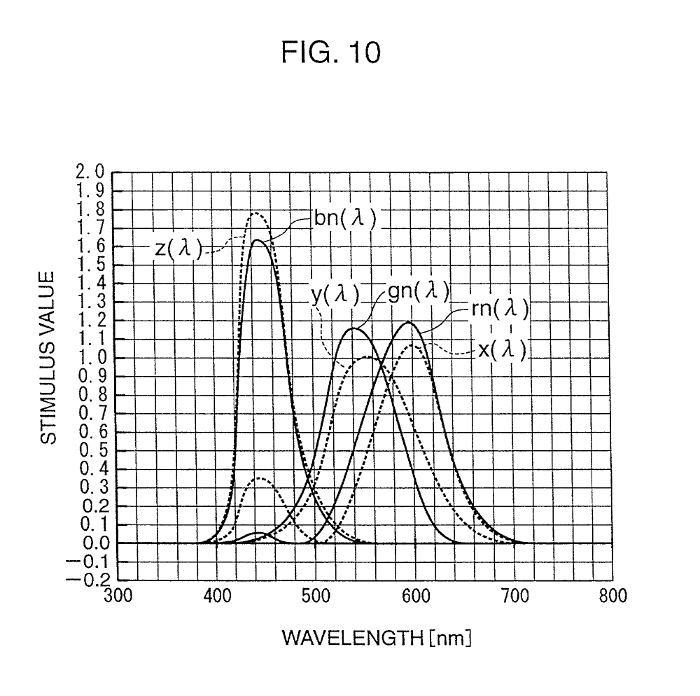

FIG. 9 shows the u′v′ chromaticity diagram in the second example of the new color system satisfying the condition “B2”. FIG. 10 shows the color matching functions of the new color system based on the new principal colors satisfying the above-mentioned condition “B2”. The side GnBn binding the apexes Gn and Bn circumscribed the spectral locus at a point about 480 nm.

The chromaticity coordinates of the new principal colors Rn, Gn, Bn and the standard white (D65) are shown in the following table 4.

TABLE 4

| | x | Y | u′ | v′ |
|---|---|---|---|---|
| Rn | 0.7347 | 0.2653 | 0.6234 | 0.5065 |
| Gn | −0.3952 | 1.3952 | −0.0770 | 0.6115 |
| Bn | 0.1457 | −0.0086 | 0.2237 | −0.0296 |
| W (D65) | 0.31277 | 0.32910 | 0.19785 | 0.46838 |

As a relation between the stimulus values Rn, Gn and Bn in the new color system and the spectral tristimulus values X, Y and Z, the following equation (30) or (31) can be obtained from the above-mentioned table 4 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}0.9552 & - 0.1886 & 0.1838 \\ 0.3449 & 0.6659 & - 0.0108 \\ 0.0000 & 0.0000 & 1.0882\end{matrix} ) ( \begin{matrix}Rn \\ Gn \\ Bn\end{matrix} ) & ( 30 ) \\ ( \begin{matrix}Rn \\ Gn \\ Bn\end{matrix} ) = ( \begin{matrix}0.9497 & 0.2690 & - 0.1577 \\ - 0.4920 & 1.3624 & 0.0966 \\ 0.0000 & 0.0000 & 0.9189\end{matrix} ) ( \begin{matrix}X \\ Y \\ Z\end{matrix} ) & ( 31 )\end{matrix}$$

The color matching functions rn(λ), gn(λ) and bn(λ) shown in FIG. 10 are obtained from the color matching functions x(λ), y(λ) and z(λ) in the XYZ color system and the above-mentioned equation (31).

The following equations (32) and (33) showing the relations between the u′v′ chromaticity coordinates and the stimulus values Rn, Gn and Bn in the new color system can be obtained from the equations (3), (4) and (30).

$$\begin{matrix}{u}^{′} = ( 3.8208 Rn - 0.7544 Gn + 0.7352 Bn ) / ( 6.1294 Rn + 9.7995 Gn + 3.2862 Bn ) & ( 32 ) \\ {v}^{′} = ( 3.1045 Rn + 5.9929 Gn - 0.0974 Bn ) / ( 6.1294 Rn + 9.7995 Gn + 3.2862 Bn ) & ( 33 )\end{matrix}$$

Similar to the first example, by replacing the numerals to the following symbols

L=6.1294, M=9.7995 and N=3.2862 (34),

the chromaticity data Dr, Dg and Db can be obtained. The chromaticity data Dw of the standard white W essentially becomes that Dw(Dr, Dg, Db)=Dw(5, 8, 3). The largest value Dg is subtracted by “1” for satisfying the above-mentioned equation (15) so that Dw(Dr, Dg, Db)=Dw(5, 7, 3), as shown in FIG. 9.

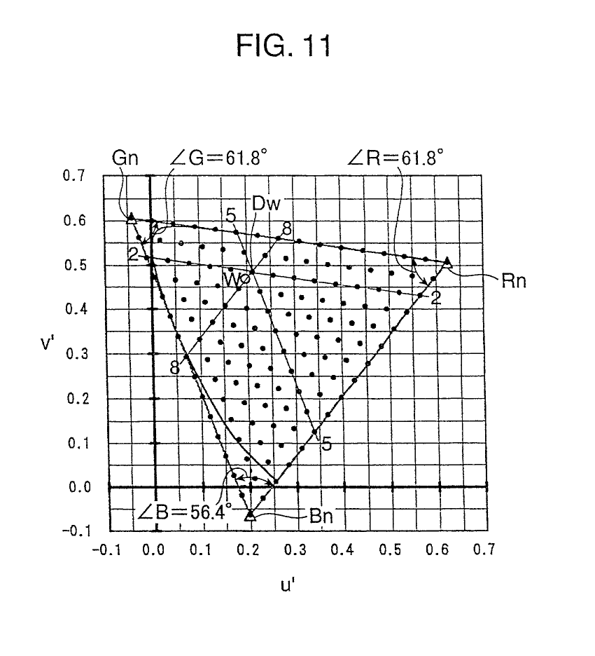

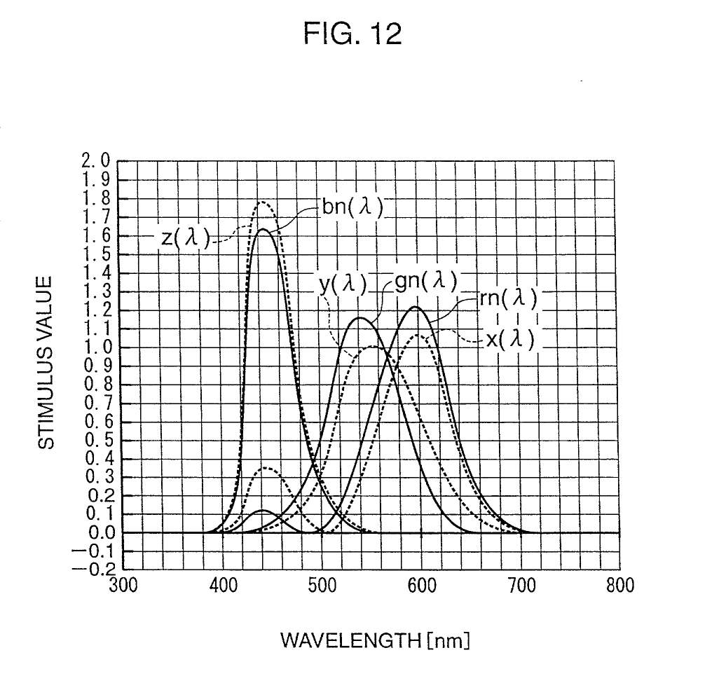

FIG. 11 shows the u′v′ chromaticity diagram in the second example of the new color system satisfying the condition “C2”. FIG. 12 shows the color matching functions of the new color system based on the new principal colors satisfying the above-mentioned condition “C2”. The side GnBn binding the apexes Gn and Bn circumscribed the spectral locus at a point about 490 nm.

The chromaticity coordinates of the new principal colors Rn, Gn, Bn and the standard white (D65) are shown in the following table 5.

TABLE 5

| | x | y | u′ | v′ |
|---|---|---|---|---|
| Rn | 0.7347 | 0.2653 | 0.6234 | 0.5065 |
| Gn | −0.1809 | 1.1809 | −0.0413 | 0.6062 |
| Bn | 0.1253 | −0.0181 | 0.1980 | −0.0642 |
| W (D65) | 0.31277 | 0.32910 | 0.19785 | 0.46838 |

As a relation between the stimulus values Rn, Gn and Bn in the new color system and the spectral tristimulus values X, Y and Z, the following equation (35) or (36) can be obtained from the above-mentioned table 5 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}0.9041 & - 0.1065 & 0.1528 \\ 0.3265 & 0.6955 & - 0.0220 \\ 0.0000 & 0.0000 & 1.0882\end{matrix} ) ( \begin{matrix}Rn \\ Gn \\ Bn\end{matrix} ) & ( 35 ) \\ ( \begin{matrix}Rn \\ Gn \\ Bn\end{matrix} ) = ( \begin{matrix}1.0480 & 0.1605 & - 0.1439 \\ - 0.4920 & 1.3624 & 0.0966 \\ 0.0000 & 0.0000 & 0.9189\end{matrix} ) ( \begin{matrix}X \\ Y \\ Z\end{matrix} ) & ( 36 )\end{matrix}$$

The color matching functions rn(λ), gn(λ) and bn(λ) shown in FIG. 12 are obtained from the color matching functions x(λ), y(λ) and z(λ) in the XYZ color system and the above-mentioned equation (36).

The following equations (37) and (38) showing the relations between the u′v′ chromaticity coordinates and the stimulus values Rn, Gn and Bn in the new color system can be obtained from the equations (3), (4) and (35).

u′=(3.6166Rn−0.4262Gn+0.6112Bn)/(5.8017Rn+10.3261Gn+3.0873Bn) (37)

v′=(2.9385Rn+6.2596Gn−0.1981Bn)/(5.8017Rn+10.3261Gn+3.0873Bn) (38)

Similar to the first example, by replacing the numerals to the following symbols

L=5.8017, M=10.3261 and N=3.0873 (39),

the chromaticity data Dr, Dg and Db can be obtained. The chromaticity data Dw of the standard white W becomes that Dw(Dr, Dg, Db)=Dw(5, 8, 2), as shown in FIG. 11.

For satisfying the above-mentioned condition “D2”, the coordinates of the apexes Gn and Bn should be decided for satisfying the conditions that ∠G+∠B=118.2 degrees and the side GnBn binding the apexes Gn and Bn circumscribes the spectral locus. Subsequently, the decided Rn, Gn and Bn are used as the new principal colors.

### Third Example of New Color System

In the third example described below, the new color system is defined on the uv chromaticity diagram instead of on the u′v′ chromaticity diagram. The relation between the chromaticity coordinates on the uv chromaticity diagram and that on the u′v′ chromaticity diagram is shown by the following equations (40) and (41).

u=u′ (40)

v=v′/1.5 (41)

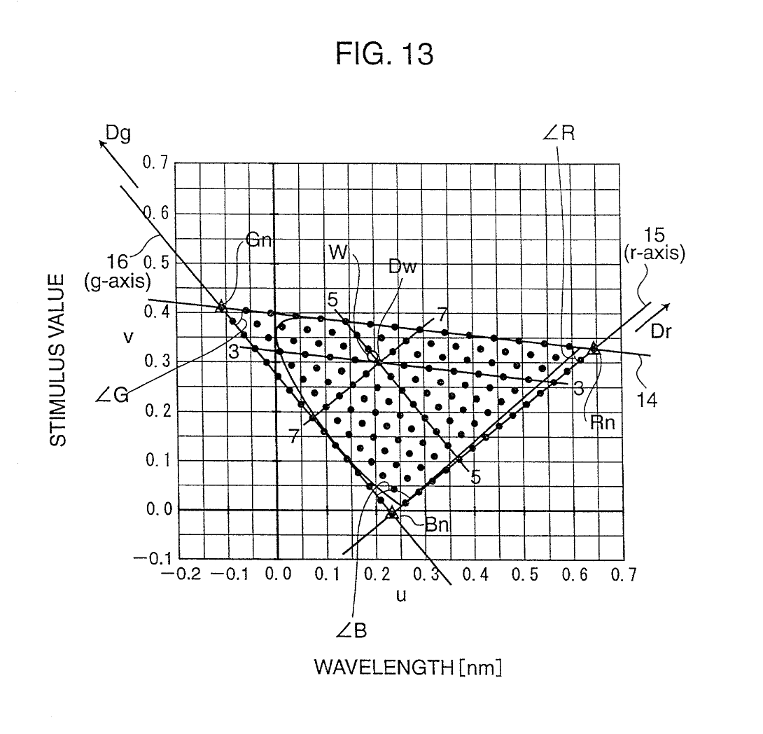

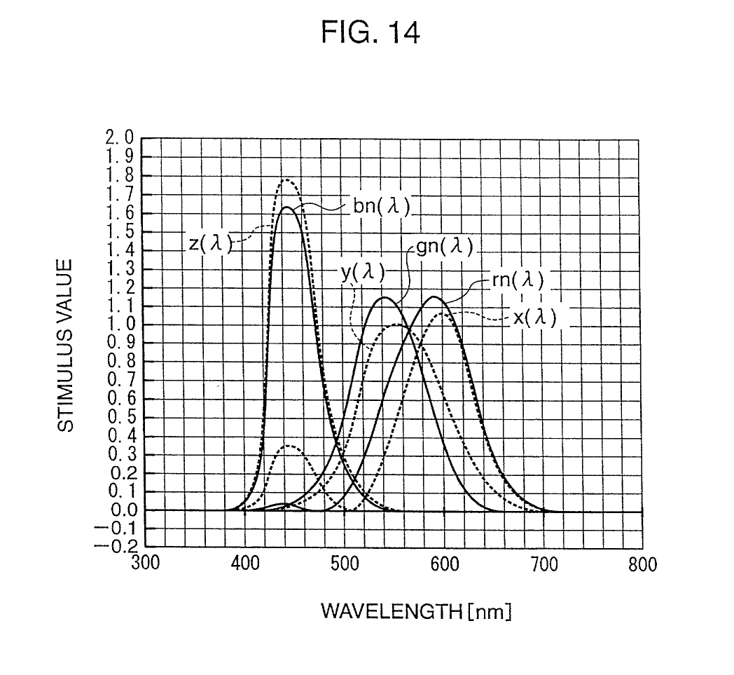

FIG. 13 shows a uv chromaticity diagram of the new color system in the third example. FIG. 14 shows color matching functions of the new color system based on new three principal colors in the third example.

In the third example, the chromaticity coordinates (apexes of triangle) of the new principal colors Rn, Gn and Bn are selected on the uv chromaticity diagram so as to satisfy the following five conditions.

A first condition is that all the chromaticity of the visible lights is included in a triangle or disposed on the sides of the triangle formed by the new principal colors Rn, Gn and Bn.

A second condition is that the apexes of Rn and Gn are disposed on a line on the uv chromaticity diagram corresponding to x+y=1 on the xy chromaticity diagram.

A third condition is that a line binding the apexes of Gn and Bn circumscribes the spectral locus of the visible lights.

A fourth condition is that a line binding the apexes of Rn and Bn circumscribes the purple boundary.

A fifth condition is that the triangle formed by the apexes of Rn, Gn and Bn is the isosceles right triangle.

The above-mentioned conditions correspond to those in the first example, so that the same effect can be obtained by satisfying the conditions.

In FIG. 13, a first straight line 14 satisfies a condition 0.1u+v=0.4 which corresponds to a line satisfying x+y=1 on the xy chromaticity diagram. A second straight line 15 crosses the first straight line 14 at an angle +45 degrees and circumscribes a part of the purple boundary. A third straight line 16 crosses the first straight line 14 at an angle −45 degrees and circumscribes a part of the spectral locus.

The crossing point of the first and second straight lines 14 and 15 is selected as the apex Rn. The crossing point of the first and third straight lines 14 and 16 is selected as the apex Gn. The crossing point of the second and third straight lines 15 and 16 is selected as the apex Bn. By such a configuration, the interior angles ∠B=90 degrees. By selecting these chromaticity coordinates of the new principal colors Rn, Gn and Bn, the above-mentioned first to fifth conditions are satisfied.

A side RnGn binding the apexes Rn and Gn of the isosceles right triangle circumscribes the spectral locus in a region of the wavelength 700 nm to 800 nm. A side GnBn binding the apexes Gn and Bn of the triangle circumscribes the spectral locus at a point about 475 nm. A side RnBn binding the apexes Rn and Bn of the triangle circumscribes the purple boundary at a point about 360 nm.

The chromaticity coordinates of the new principal colors Rn, Gn, Bn and the standard white (D65) are shown in the following table 6.

TABLE 6

| | x | y | u | v |
|---|---|---|---|---|
| Rn | 0.7455 | 0.2545 | 0.6536 | 0.3346 |
| Gn | −0.6717 | 1.6717 | −0.1101 | 0.4110 |
| Bn | 0.1544 | −0.0040 | 0.2336 | −0.0090 |
| W (D65) | 0.31277 | 0.32910 | 0.19785 | 0.31225 |

As a relation between the stimulus values Rn, Gn and Bn in the new color system and the spectral tristimulus values X, Y and Z, the following equation (42) or (43) can be obtained from the above-mentioned table 6 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}1.0170 & - 0.2644 & 0.1977 \\ 0.3472 & 0.6579 & - 0.0051 \\ 0.0000 & 0.0000 & 1.0882\end{matrix} ) ( \begin{matrix}Rn \\ Gn \\ Bn\end{matrix} ) & ( 42 ) \\ ( \begin{matrix}Rn \\ Gn \\ Bn\end{matrix} ) = ( \begin{matrix}0.8647 & 0.3474 & - 0.1555 \\ - 0.4562 & 1.3366 & 0.0891 \\ 0.0000 & 0.0000 & 0.9189\end{matrix} ) ( \begin{matrix}X \\ Y \\ Z\end{matrix} ) & ( 43 )\end{matrix}$$

The color matching functions rn(λ), gn(λ) and bn(λ) shown in FIG. 14 is obtained from the color matching functions x(λ), y(λ) and z(λ) in the XYZ color system and the above-mentioned equation (43).

The following equations (44) and (45) showing the relations between the uv chromaticity coordinates and the stimulus values Rn, Gn and Bn in the new color system can be obtained from the equations (3), (4), (40), (41) and (42).

$$\begin{matrix}u = ( 4.0628 Rn - 1.0574 Gn + 0.7909 Bn ) / ( 6.2243 Rn + 9.6047 Gn + 3.3861 Bn ) & ( 44 ) \\ v = ( 2.0829 Rn + 3.9476 Gn - 0.0305 Bn ) / ( 6.2243 Rn + 9.6047 Gn + 3.3861 Bn ) & ( 45 )\end{matrix}$$

Steps for setting the chromaticity coordinates of the new principal colors Rn, Gn and Bn satisfying the above-mentioned first to fifth conditions are similar to those in the above-mentioned first example.

Since the denominators of the above-mentioned equations (44) and (45) which defines the uniformity of the graduation of the coordinate axes, are the same, similar to in the case of using the u′v′ chromaticity diagram. Thus, the denominator of the above-mentioned equation (44) or (45) is used as the sum of the stimulus values S in the stimulus values Rn, Gn and Bn, the chromaticity coordinates r, g and b can be shown as following equations (46) to (49).

r=L·Rn/S (46)

g=M·Gn/S (47)

b=N·Bn/S (48)

r+g+b=1 (49)

L=6.2243, M=9.6047, N=3.3861 (50)

$$S = L \cdot Rn + M \cdot Gn + N \cdot Bn \\ 0 ≦ r , g , b ≦ 1 \qquad ( 51 )$$

When the equations (44) and (45) are compared with the equations (46) to (48), the numerators of the chromaticity coordinates r, g and b in the equations (46) to (48) are simplified from those in the uv chromaticity coordinates, so that the calculation of the chromaticity coordinates can be made faster by using the chromaticity coordinates r, g and b.

When the chromaticity coordinates r, g and b are quantized, the chromaticity data Dr, Dg and Db which are digital data can be obtained. The following equation (52) holds good for the chromaticity data Dr, Dg and Db. Hereupon the symbol “n” designates the bit number of the quantization.

Dr+Dg+Db=2ⁿ−1 (52)

In the two-dimensional space of the chromaticity coordinates, it is possible to point the position of the coordinate by using only two values among the three quantized values. For example, the coordinates shown by using the chromaticity data Dr and Dg are described with reference to FIG. 13. In FIG. 13, the marks “●” designate the positions (quantization points) of the chromaticity data Dr and Db on the uv chromaticity diagram. In this example, the bit number of the quantization “n” is selected to be “4” (n=4).

As can be seen from FIG. 13, the marks “●” are disposed at a predetermined interval along r-axis and g-axis. In other words, the quantization points are arranged at apexes of the square. As a result, the chromaticity data of the object taken by the imaging apparatus can be quantized two-dimensionally on the uv chromaticity diagram, uniformly.

Similar to the u′v′ chromaticity diagram, the uv chromaticity diagram is graduated so that the sensory difference between two different colors having the same brightness will be substantially in proportion two the geometrical distance between the coordinates of the colors on the diagram at any point on the diagram. Thus, the noise of the quantized chromaticity with respect to the bit number of the quantization can be made the smallest by quantizing the uv chromaticity diagram, uniformly. The chromaticity data can be regarded as perception value.

The chromaticity data Dr, Dg and Db can be obtained similar to the above-mentioned first example. For example, the chromaticity data of the standard white becomes that Dw(Dr, Dg, Db)=Dw(5, 7, 3).

Similar to the above-mentioned first example, the range of wavelengths of the visible lights is selected from 360 nm to 800 nm in the third example. It is possible to use the range from 400 nm to 700 nm which is generally used as the range of the visible lights.

### Fourth Example of the New Color System

In the fourth example of the new color system, the conditions similar to the above-mentioned second example are satisfied on the uv chromaticity diagram.

A first condition is that all the chromaticity of the visible lights is included in a triangle or disposed on the sides of the triangle formed by the new principal colors Rn, Gn and Bn.

A second condition is that the apexes of Rn and Gn are disposed on a line on the uv chromaticity diagram corresponding to x+y=1 on the xy chromaticity diagram.

A third condition is that a line binding the apexes of Gn and Bn circumscribes the spectral locus of the visible lights.

A fourth condition is that a line binding the apexes of Rn and Bn superimposes on the purple boundary.

The apex Rn of the triangle is selected to be the crossing point of the purple boundary and the line 0.1u+v=0.4 corresponding to the line x+y=1 on the xy chromaticity diagram. Since the interior angle ∠R≈47.5 degrees, at this time, any one of the following four conditions “A4” to “D4” is satisfied, instead of the fifth condition in the above-mentioned third example.

The condition “A4” is that the triangle formed by the new principal colors Rn, Gn and Bn is an isosceles triangle in which the interior angle ∠R with respect to the apex Rn is 47.5 degrees (∠R=47.5 degrees), and the other interior angles∠G and ∠B with respect to the apexes Gn and Bn are to be 66.3 degrees (∠G=∠B=(180−47.5)/2=66.3 degrees).

The condition “B4” is that the triangle formed by the new principal colors Rn, Gn and Bn is an isosceles triangle in which the interior angles ∠R and ∠B with respect to the apexes Rn and Bn are to be 47.5 degrees (∠R=∠B=47.5 degrees), and the other interior angle ∠G with respect to the apex Gn is 85.0 degrees (∠G=(180−47.5×2)=85.0 degrees).

The condition “C4” is that the triangle formed by the new principal colors Rn, Gn and Bn is an isosceles triangle in which the interior angles ∠R and ∠G with respect to the apexes Rn and Gn are to be 47.5 degrees (∠R=∠G=47.5 degrees), and the other interior angle ∠B with respect to the apex Bn is 85.0 degrees (∠B=(180−47.5×2)=85.0 degrees).

The condition “D4” is that the triangle formed by the new principal colors Rn, Gn and Bn is a triangle in which the interior angle ∠R with respect to the apex Rn is 47.5 degrees (∠R=47.5 degrees), and the other interior angles ∠G and ∠B with respect to the apexes Gn and Bn satisfy the equation of ∠G+∠B=180−47.5=132.5 degrees.

When the triangle formed by the new principal colors Rn, Gn and Bn is made to be the isosceles triangle by satisfying one of the conditions “A4” to “C4”, the quantization points are uniformly distributed along the quantization axes on the uv chromaticity diagram, and the isosceles two axes have the same gradation pitch. On the other hand, when the triangle formed by the new principal colors Rn, Gn and Bn is made not to be the isosceles triangle by satisfying the condition “D4”, the quantization points are uniformly distributed along respective three quantization axes on the uv chromaticity diagram.

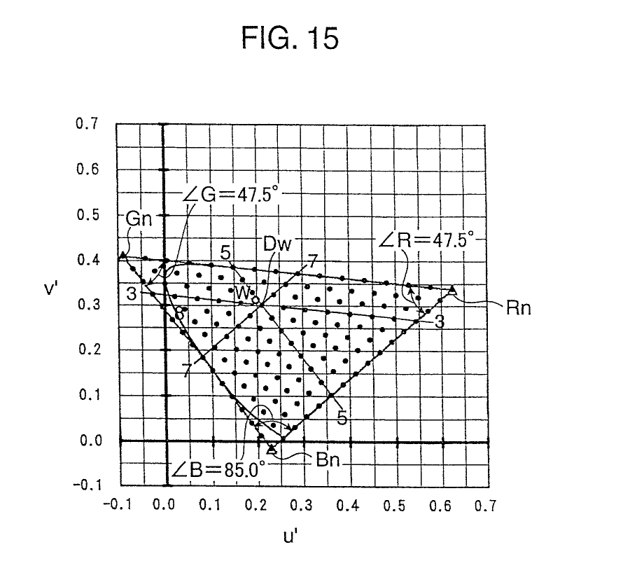

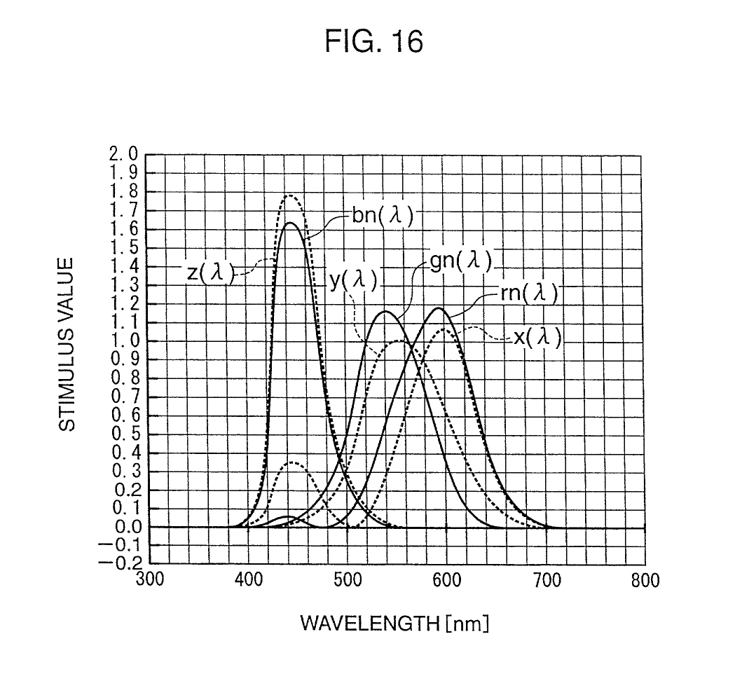

FIG. 15 shows the uv chromaticity diagram in the fourth example of the new color system satisfying the condition “C4”. FIG. 16 shows the color matching functions of the new color system based on the new principal colors satisfying the above-mentioned condition “C4”. The explanations of the chromaticity diagram and the color matching functions with respect to the conditions “A4” and “B4” are omitted.

The side GnBn binding the apexes Gn and Bn circumscribed the spectral locus at a point about 475 nm.

The chromaticity coordinates of the new principal colors Rn, Gn, Bn and the standard white (D65) are shown in the following table 7.

TABLE 7

| | x | y | u | v |
|---|---|---|---|---|
| Rn | 0.7347 | 0.2653 | 0.6234 | 0.3377 |
| Gn | −0.4852 | 1.4852 | −0.0891 | 0.4089 |
| Bn | 0.1494 | −0.0069 | 0.2283 | −0.0157 |
| W (D65) | 0.31277 | 0.32910 | 0.19785 | 0.31225 |

As a relation between the stimulus values Rn, Gn and Bn in the new color system and the spectral tristimulus values X, Y and Z, the following equation (53) or (54) can be obtained from the above-mentioned table 7 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}0.9752 & - 0.2145 & 0.1897 \\ 0.3522 & 0.6565 & - 0.0087 \\ 0.0000 & 0.0000 & 1.0882\end{matrix} ) ( \begin{matrix}Rn \\ Gn \\ Bn\end{matrix} ) & ( 53 ) \\ ( \begin{matrix}Rn \\ Gn \\ Bn\end{matrix} ) = ( \begin{matrix}0.9172 & 0.2996 & - 0.1575 \\ - 0.4920 & 1.3624 & 0.0966 \\ 0.0000 & 0.0000 & 0.9189\end{matrix} ) ( \begin{matrix}X \\ Y \\ Z\end{matrix} ) & ( 54 )\end{matrix}$$

The color matching functions rn(λ), gn(λ) and bn(λ) shown in FIG. 16 are obtained from the color matching functions x(λ), y(λ) and z(λ) in the XYZ color system and the above-mentioned equation (54).

The following equations (55) and (56) showing the relations between the uv chromaticity coordinates and the stimulus values Rn, Gn and Bn in the new color system can be obtained from the equations (3), (4), (40), (41) and (53).

$$\begin{matrix}u = ( 3.9008 R n - 0.8579 G n + 0.7587 B n ) / ( 6.2577 R n + 9.6335 G n + 3.3239 B n ) & ( 55 ) \\ v = ( 2.1130 R n + 3.9392 G n - 0.0522 B n ) / ( 6.2577 R n + 9.6335 G n + 3.3239 B n ) & ( 56 )\end{matrix}$$

Similar to the first example, by replacing the numerals to the following symbols

L=6.2557, M=9.6335 and N=3.3239 (57),

the chromaticity data Dr, Dg and Db can be obtained. The chromaticity data Dw of the standard white W essentially becomes that Dw(Dr, Dg, Db)=Dw(5, 8, 3). The largest value Dg is subtracted by “1” for satisfying the above-mentioned equation (15) so that Dw(Dr, Dg, Db)=Dw(5, 7, 3), as shown in FIG. 15.

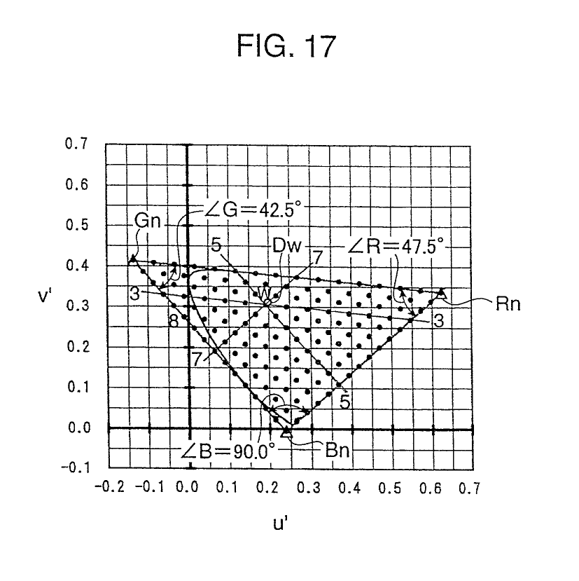

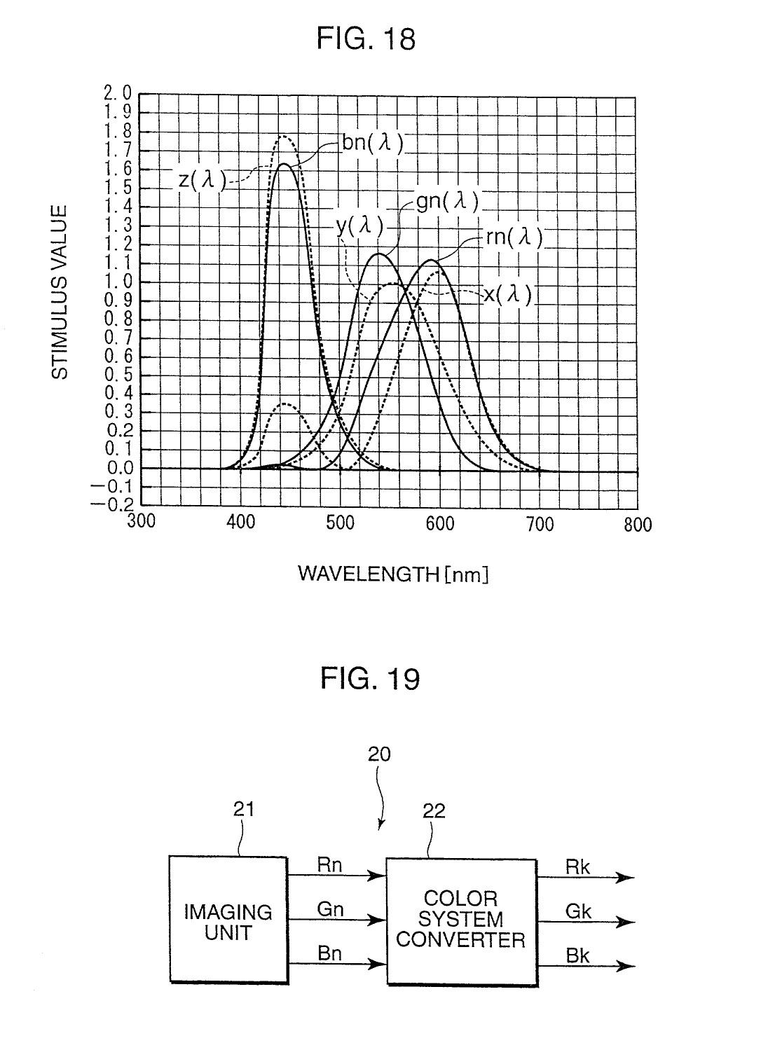

FIG. 17 shows the uv chromaticity diagram in the fourth example of the new color system satisfying the condition “D4”. FIG. 18 shows the color matching functions of the new color system based on the new principal colors satisfying the above-mentioned condition “D4”. In FIG. 17, the interior angle of the apex Bn is the right angle, that is, ∠R=47.5 degrees, ∠G=42.5 degrees and ∠B=90.0 degrees. The line GnBn binding the apexes Gn and Bn circumscribed the spectral locus at a point about 470 nm.

The chromaticity coordinates of the new principal colors Rn, Gn, Bn and the standard white (D65) are shown in the following table 8.

TABLE 8

| | x | y | u | v |
|---|---|---|---|---|
| Rn | 0.7347 | 0.2653 | 0.6234 | 0.3377 |
| Gn | −0.9699 | 1.9699 | −0.1358 | 0.4136 |
| Bn | 0.1587 | −0.0026 | 0.2393 | −0.0058 |
| W (D65) | 0.31277 | 0.32910 | 0.19785 | 0.31225 |

As a relation between the stimulus values Rn, Gn and Bn in the new color system and the spectral tristimulus values X, Y and Z, the following equation (58) or (59) can be obtained from the above-mentioned table 8 and the equations (1) and (2). Hereupon, 0≦Rn, Gn and Bn≦1. The largest value of the stimulus value Y is standardized to be “1” when the stimulus values Rn=Gn=Bn=1.

$$\begin{matrix}( \begin{matrix}X \\ Y \\ Z\end{matrix} ) = ( \begin{matrix}1.0526 & - 0.3068 & 0.2046 \\ 0.3801 & 0.6232 & - 0.0033 \\ 0.0000 & 0.0000 & 1.0882\end{matrix} ) ( \begin{matrix}R n \\ G n \\ B n\end{matrix} ) & ( 58 ) \\ ( \begin{matrix}R n \\ G n \\ B n\end{matrix} ) = ( \begin{matrix}0.8066 & 0.3971 & - 0.1504 \\ - 0.4920 & 1.3624 & 0.0966 \\ 0.0000 & 0.0000 & 0.9189\end{matrix} ) ( \begin{matrix}X \\ Y \\ Z\end{matrix} ) & ( 59 )\end{matrix}$$

The color matching functions rn(λ), gn(λ) and bn(λ) shown in FIG. 18 are obtained from the color matching functions x(λ), y(λ) and z(λ) in the XYZ color system and the above-mentioned equation (59).

The following equations (60) and (61) showing the relations between the uv chromaticity coordinates and the stimulus values Rn, Gn and Bn in the new color system can be obtained from the equations (3), (4), (40), (41) and (58).

u=(4.2106Rn−1.2273Gn+0.8184Bn)/(6.7546Rn+9.0409Gn+3.4196Bn) (60)

v=(2.2808Rn+3.7391Gn−0.0199Bn)/(6.7546Rn+9.0409Gn+3.4196Bn) (61)

Similar to the first example, by replacing the numerals to the following symbols

L=6.7546, M=9.0409 and N=3.4196 (62),

the chromaticity data Dr, Dg and Db can be obtained. The chromaticity data Dw of the standard white W essentially becomes that Dw(Dr, Dg, Db)=Dw(5, 8, 3). The largest value Dg is subtracted by “1” for satisfying the above-mentioned equation (15) so that Dw(Dr, Dg, Db)=Dw(5, 7, 3), as shown in FIG. 17.

As mentioned above, several kinds of the three principal colors and the new color system based on the new principal colors are proposed. In the imaging apparatus 1 in the embodiment, the stimulus values Rn, Gn and Bn, the sum of the stimulus values S, the chromaticity coordinates r, g and b, or the chromaticity data Dr, Dg and Db are memorized in the memory unit 7 as the image data. Alternatively, it is possible to memorize the tristimulus values X, Y and Z, which are converted by following the equation (5) in the memory unit 7.

With respect to the color matching functions rn(λ), gn(λ) and bn(λ) which are obtained from the new principal colors in the above-mentioned examples, the stimulus values take only zero or the positive value in the whole range of the visible lights. For realizing the spectral sensitivity characteristics of the optical filters 4R, 4G and 4B coinciding with or similar to the color matching functions rn(λ), gn(λ) and bn(λ), no photoelectric transfer device having the negative sensitivity is necessary. As a result, all the colors can be taken as the image data by the imaging apparatus 1 in this embodiment, so that the imaging area of the color can be expanded.

Furthermore, the new principal colors Rn, Gn and Bn are selected in a manner so that the quantized chromaticity data of the image signals are uniformly distributed in the UCS color space in which the sensory difference between two different colors having the same brightness will be substantially in proportion two the geometrical distance between the coordinates of the colors. Thus, the distribution of the noise of quantization in the color space can be optimized, when the bit number of the quantization of the image signals is considered.

The quantized chromaticity data can be regarded as the perceptible chromaticity data, so that it is suitable for increasing the performance, the function or the perception adaptability of the imaging apparatus such as the automatic white balancing process (AWB), the color transfer process in the color reproduction.

The quantized chromaticity data can be used in the analysis of the image data and the control of the color transfer function. In the typical imaging apparatus such as the compact video camera or the digital still camera, the white balancing process is executed by judging the color temperature of the illumination light source from the image signals, which is called TTL-AWB.

Furthermore, the optical filters 4R, 4G and 4b are necessary to be manufactured in a manner so that the spectral sensitivity characteristics of the optical filters 4R, 4G and 4B coinciding with or similar to the color matching functions rn(λ), gn(λ) and bn(λ). Thus, there are advantages that the number of the parts constituting the imaging apparatus and the cost of the imaging apparatus are not so increased.

Furthermore, the new principal colors are selected in a manner so that the ratio of the area of the visible lights with respect to the area of the triangle formed by the three apexes can be made as larger as possible, and the area of the triangle can be utilized effectively. The ratio of the combination of the signals actually used with respect to the total number of the combination of the signal data defined by the bit number of the quantization of the principal color signals in the new color system becomes higher. The same rule can be applied to quantize the chromaticity signals, so that a color space having a high efficiency of the data utility can be realized, entirely. In other words, the ratio of the quantization points disposed out of the area of the visible lights becomes smaller. As a result, the color space having a high data efficiency can be realized as a whole.

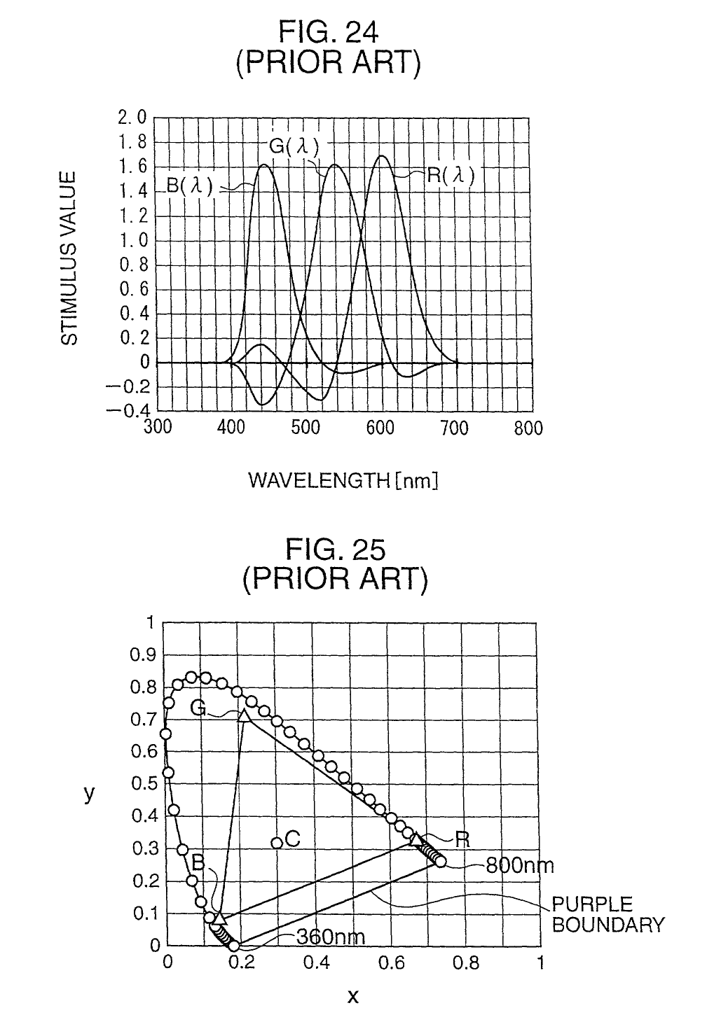

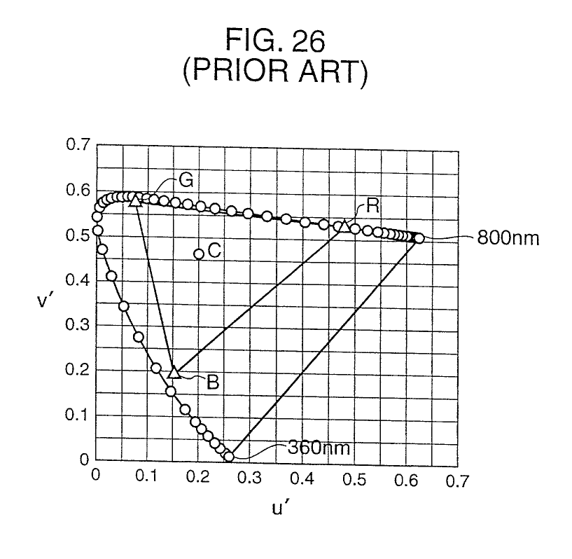

When the color matching functions illustrated in FIGS. 3, 8, 10, 12, 14, 16 and 18 are compared with the spectral sensitivity characteristics illustrated in FIG. 24, it is found that the bottom portion of the color matching functions gn(λ) of the new principal colors are formed gentle than that in the positive portion of the ideal spectral sensitivity characteristic G(λ). Thus, the transmittance of the optical filter 4G satisfying the spectral sensitivity characteristics in this embodiment can be made higher. As a result, the imaging apparatus having a high sensitivity can be realized, so that the image of the object having much lower luminance can be taken by the imaging apparatus.

The above-mentioned embodiment of the present invention can be modified as follows. In the above-mentioned description, the bit number of the quantization “n” is selected to be by “4” (n=4). It, however, is not restricted by this example. Since the quantization is executed by using the smaller bit number such as “4”, the points P and Dp or the points W and Dw are not coincided with each other as shown in FIG. 4. When the bit number of the quantization “n” is made larger, it is possible to coincide the points P and W with the point Dp and Dw, respectively. When the bit number of the quantization “n” is selected to a predetermined number, for example n=7 or 8, in a manner so that the color difference between quantization points cannot be recognized by human perception, the affection due to the quantization error can substantially be ignored.

As can be seen from FIGS. 3, 8, 10, 12, 14, 16 and 18, the color matching functions rn(λ) of the new color system respectively have responsible portions in the shorter wavelength region having the center wavelength about 440 nm and the middle wavelength region having the center wavelength about 600 nm. For realizing the color matching function rn(λ) precisely, it is necessary to provide four kinds of optical filters. On the other-hand, when the required color reproduction accuracy of the imaging apparatus is not so high, it is possible to omit the responsible portion in the shorter wavelength region of the color matching function rn(λ), since the response level in the shorter wavelength region is smaller than that of the color matching function x(λ).

In the imaging apparatus in accordance with this embodiment, only the spectral sensitivity characteristics of the optical filters 4R, 4G and 4B are different from those of the conventional color imaging apparatus using the principal colors of R, G and B. Thus, the new color system in accordance with this embodiment can be applied to all kinds of the imaging apparatus 1 with no relation to the configuration of the imaging unit 5 such as the single imaging device or the multiple imaging devices. The imaging apparatus 1 further includes a digital still camera, a document reader (document scanner), a film reader (film scanner), and so on.

### Image Data Converting Apparatus

Subsequently, an embodiment of an image data converting apparatus in accordance with the present invention is described. Since the above-mentioned new principal colors can include imaginary colors, they are different from the principal colors of the conventional image outputting apparatus. The image data converting apparatus in the embodiment converts the image data based on the new color system taken by the above-mentioned imaging apparatus 1 to the image data based on the known principal colors Rk, Gk and Bk, and outputs the converted image data to the known image outputting apparatus. The fidelity of the color reproduction of the chromaticity of the object disposed in the triangle formed by the known principal colors Rk, Gk and Bk on the chromaticity diagram will be increased.

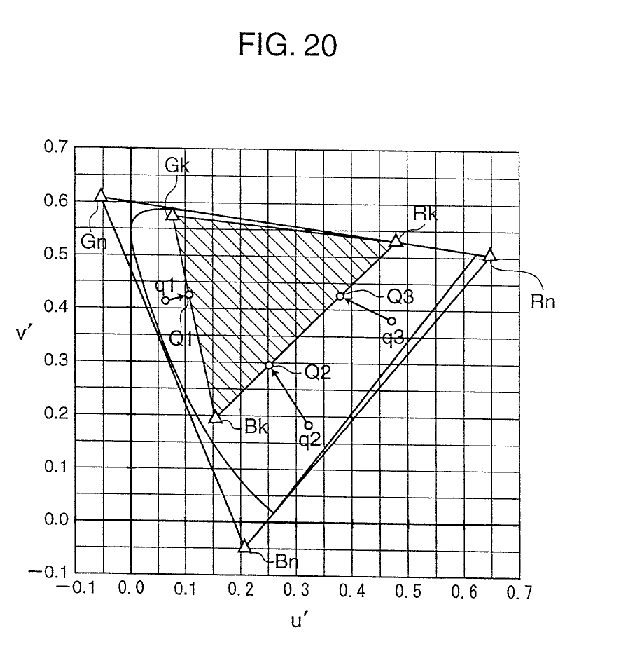

FIG. 19 is a block diagram showing a first example of an electric configuration of the image data converting apparatus in the embodiment. FIG. 20 is a u′v′ chromaticity diagram for showing an image data converting processing in the first example. The new principal colors Rn, Gn and Bn in the above-mentioned first example of the new color system in which the triangle formed by the new principal colors are the equilateral triangle are used.

As can be seen from FIG. 19, the image data converting apparatus 20 comprises. an imaging unit 21 and a color system converter 22. The imaging unit 21 for taking an image of an object has substantially the same configuration as that of the imaging apparatus 1 shown in FIG. 1. The imaging unit 21 includes three kinds of optical filters and a photoelectric transfer device. The three kinds of the optical filters respectively have spectral sensitivity characteristics similar to the color matching functions of the new principal colors Rn, Gn and Bn.

The color system converter 22 converts the image signals based on the new principal colors Rn, Gn and Bn outputted from the imaging unit 21 to the image signals based on the known principal colors Rk, Gk and Bk. In this example, the converted image signals are, for example, the image signals corresponding to the NTSC television standard. The converted image signals are outputted to the image outputting apparatus such as the television based on the known principal colors Rk, Gk and Bk corresponding to the NTSC television standard.

The image data converting process in the color system converter 22 is described. The chromaticity coordinates of the known principal colors Rk, Gk, Bk and the standard white W(C) in the NTSC television standard are shown in the following table 9.

TABLE 9

| | x | y | u′ | v′ |
|---|---|---|---|---|
| Rk | 0.6700 | 0.3300 | 0.4769 | 0.5285 |
| Gk | 0.2100 | 0.7100 | 0.0757 | 0.5757 |
| Bk | 0.1400 | 0.0800 | 0.1522 | 0.1957 |
| W (C) | 0.31007 | 0.31623 | 0.20087 | 0.46093 |

As a relation between the stimulus values Rk, Gk and Bk in the known color system of the image outputting apparatus and the spectral tristimulus values X, Y and Z, the following equation (63) can be obtained from the above-mentioned table 9.

$$( \begin{matrix}X \\ Y \\ Z\end{matrix} ) = ( \begin{matrix}0.6067 & 0.1735 & 0.2002 \\ 0.2988 & 0.5867 & 0.1144 \\ 0.0000 & 0.0661 & 1.1157\end{matrix} ) ( \begin{matrix}R k \\ G k \\ B k\end{matrix} ) \qquad ( 63 )$$

When the equation (63) is modified, the following equation (64) is obtained.

$$( \begin{matrix}R k \\ G k \\ B k\end{matrix} ) = ( \begin{matrix}1.9105 & - 0.5326 & - 0.2883 \\ - 0.9844 & 1.9987 & - 0.0283 \\ 0.0583 & - 0.1184 & 0.8980\end{matrix} ) ( \begin{matrix}X \\ Y \\ Z\end{matrix} ) \qquad ( 64 )$$

Subsequently, when the equation (64) is subtracted into the above-mentioned equation (5), the following equation (65) is obtained.

$$( \begin{matrix}R k \\ G k \\ B k\end{matrix} ) = ( \begin{matrix}1.5909 & - 0.6290 & 0.0075 \\ - 0.2692 & 1.5275 & - 0.2259 \\ 0.0160 & - 0.0905 & 0.9888\end{matrix} ) ( \begin{matrix}R n \\ G n \\ B n\end{matrix} ) \qquad ( 65 )$$

In the equation (65), when the luminance of the input signal becomes the largest (Y=1, Rn=Gn=Bn=1), the stimulus values Rk, Gk and Bk take the values Rk=0.9694, Gk=1.0323 and Bk=0.9142. Generally, one of the values Rk, Gk and Bk becomes larger than “1”, so that it is necessary for standardizing the stimulus values. In this example, since the value Gk=1.0323, the above-mentioned equation (65) is standardized so as to obtain the following equation (66). The color system converter 22 converts the image signals by using the equation (66).

$$( \begin{matrix}R k \\ G k \\ B k\end{matrix} ) = ( \begin{matrix}1.5411 & - 0.6093 & 0.0073 \\ - 0.2608 & 1.4797 & - 0.2189 \\ 0.0155 & - 0.0877 & 0.9579\end{matrix} ) ( \begin{matrix}R n \\ G n \\ B n\end{matrix} ) \qquad ( 66 )$$

As can be seen from FIG. 20, the chromaticity in a hatched area in which the area of the triangle formed by the new principal colors Rn, Gn and Bn and the area of the triangle formed by the known principal colors Rk, Gk and Bk are maintained after the color system converting process. By such the configuration, the reduction of the fidelity of the color reproduction of the internal chromaticity which was the disadvantage of the conventional color system can be solved.

The external chromaticity disposed outside of the triangle formed by the known principal colors Rk, Gk and Bk but inside of the area of the visible lights are converted to the chromaticity coordinate compressed to the sides of the triangle formed by the known principal colors Rk, Gk and Bk. For example, the image signals of the points q1, q2 and q3 on the u′v′ chromaticity diagram shown in FIG. 20 are converted to the image signals of the points Q1, Q2 and Q3. It is regarded as the compression of the color saturation of the external chromaticity.

A second example of the color system converting apparatus in the embodiment is described. In the above-mentioned first example of the color system converting apparatus, the image signals are linearly converted by using the equation (66). In the second example of the color system converting apparatus, the chromaticity data based on the new principal colors are, at first, converted to the chromaticity data in the area of color reproduction of the conventional image outputting apparatus by following a predetermined converting manner. Subsequently, the converted chromaticity data is further converted to the image data based on the known principal colors by following the equation (66). Thus, the color system conversion process in the second example becomes nonlinear.

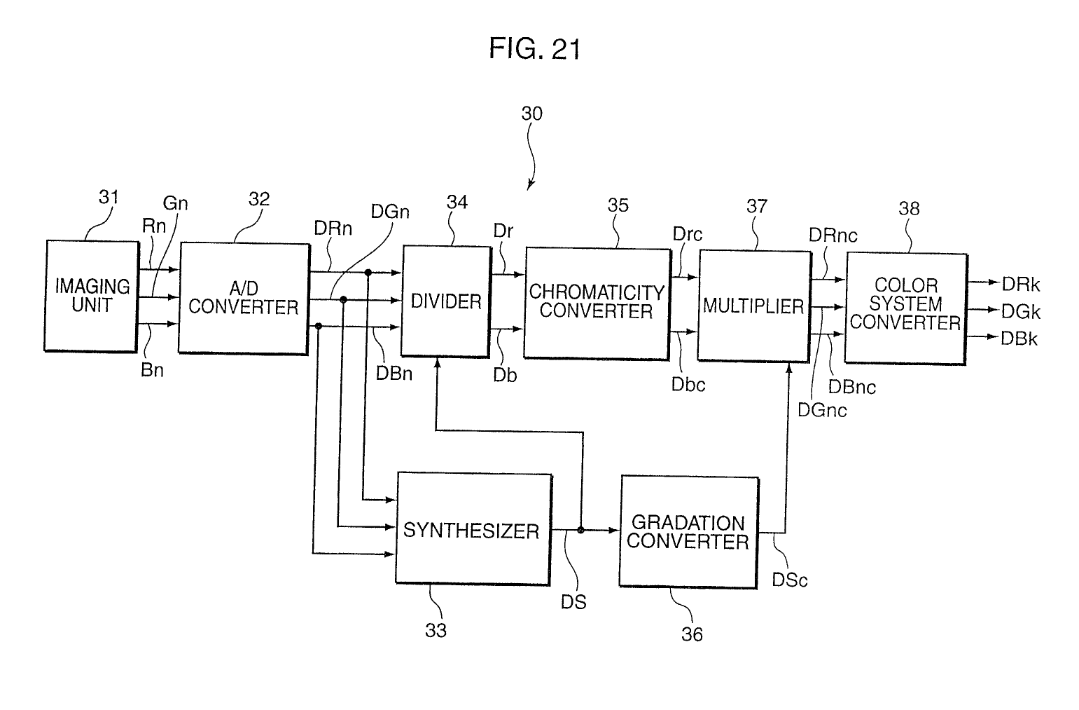

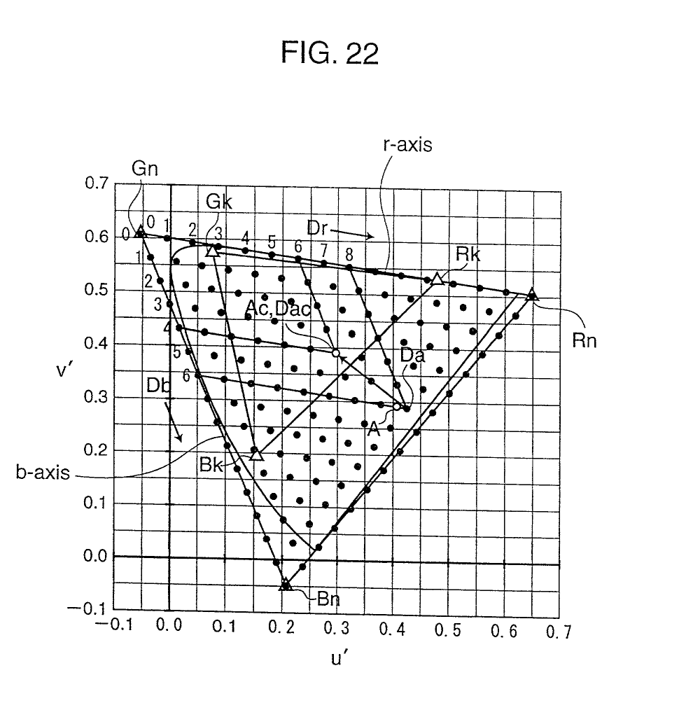

FIG. 21 is a block diagram showing the second example of an electric configuration of the image data converting apparatus in the embodiment. FIG. 22 is a u′v′ chromaticity diagram for showing the image data converting processing in the second example. The new principal colors Rn, Gn and Bn in the above-mentioned first example of the new color system in which the triangle formed by the new principal colors are the equilateral triangle are used.

In FIG. 21, the imaging unit 31 for taking an image of an object has substantially the same configuration as that of the imaging apparatus 1 shown in FIG. 1. The imaging unit 31 includes three kinds of optical filters and a photoelectric transfer device. The three kinds of the optical filters respectively have spectral sensitivity characteristics similar to the color matching functions of the new principal colors Rn, Gn and Bn.

An A/D converter 32 converts the analogous color image signals Rn, Gn and Bn outputted from the imaging unit 31 to digital values and outputs the digital values as image data DRn, DRg and DRb. A synthesizer 33 generates a sum of the stimulus values S (in this description, it is called stimulus sum data DS) based on the above-mentioned equations (13) and (14). A divider 34 generates two of the chromaticity data Dr, Dg and Db from the image data DRn, DGn, DBn and the by dividing the stimulus sum data DS by following the equations (9) to (11). In this example, the chromaticity data Dr and Db are generated.

A chromaticity converter 35 comprises a lookup table or a predetermined calculator for executing the compensation of the color reproduction such as the γ compensation and the data conversion for responding to the characteristics of the image outputting apparatus so as to realize the inherent effect. The chromaticity converter 35 converts the chromaticity data Dr and Db to the compensated chromaticity data Drc and Dbc and outputs the compensated chromaticity data Drc and Dbc. The nonlinear process is executed by the chromaticity converter 35.

A gradation converter 36 converts the stimulus sum data DS so as to be desired characteristic and outputs the compensated stimulus sum data DSc. A multiplier 37 multiplies the compensated chromaticity data Drc and Dbc by the compensated stimulus sum data DSc for generating the compensated image data DRnc, DGnc and DBnc, and outputs them.

By modifying the above-mentioned equations (9) to (12), the compensated stimulus values Rnc, Gnc and Bnc are shown as the following equations (67) to (69).

Rnc=rc·Sc/L (67)

Gnc=(1−rc−bc)·Sc/M (68)

Bnc=bc·Sc/N (69)

These equations (67) to (69) respectively correspond to the following equations (70) to (72).

DRnc=K·Drc·DSc/L (70)

DGnc=K·(2ⁿ−1−Drc−Dbc)·DSc/M (71)

DBnc=K·Dbc·DSc/N (72)

Hereupon, the symbol “K” designates a proportional constant.

The multiplier 37 calculates the compensated image data DRnc, DGnc and DBnc by following the above-mentioned equations (70) to (72). The compensated image data DRnc, DGnc and DBnc show the image data corresponding to the characteristics decided by the chromaticity converter 35 and the gradation converter 36.

A color system converter 38 converts the compensated image data DRnc, DGnc and DBnc based on the new principal colors in the new color system to the image data DRk, DGk and DGb based on the known principal colors in the conventional NTSC television standard used in the conventional image outputting apparatus by following the above-mentioned equation (66).

Subsequently, an example of the converting process for converting the inputted image data is concretely described with reference to FIG. 22.

It is assumed that an image data of Rn=0.5, Gn=0.05 and Bn=0.7 are obtained in an imaging operation of an object. The u′v′ chromaticity coordinate A(u′, v′) of the image data becomes A(u′, v′)=A(0.4067, 0.2938) by following the above-mentioned equations (7) and (8).

On the other hand, the sum of the stimulus values S is calculated as S=5.5915 by following the equations (13) and (14). The chromaticity coordinates r, g and b in the new color system are calculated as r=0.5107, g=0.0924 and b=0.3970 from the sum of the stimulus values S and the equations (9) to (11). Furthermore, the quantized chromaticity data Dr, Dg and Db of the chromaticity coordinates r, g and b become Dr=8, Dg=1 and Db=6.

In FIG. 22, the apex Gn designates the origin and the chromaticity data is shown by graduated by following the r-axis (Dr) and b-axis (Db). The point having the chromaticity coordinates Da(Dr, Db)=Da(8, 6) is illustrated as the point Da. In this case, the point Da is the external chromaticity.

For converting the external chromaticity Da to an internal chromaticity, the external chromaticity data Da(Dr, Db)=Da(8, 6) is converted to the internal chromaticity data Dac(Drc, Dbc)=Dac(6, 4) by using the two-dimensional lookup table in the chromaticity converter 35. The internal chromaticity data Dac is outputted from the chromaticity converter 35. Hereinafter, respective values will be treated as continuous values.

The chromaticity values Rnc, Gnc and Bnc are calculated as follows by following the equations (12), (13), (14), (67), (68) and (69).

$$\begin{matrix}R n c = r c \cdot S c / L \\ = 6 / ( {2}^{n} - 1 ) \cdot 5.5915 / 5.7109 \\ = 0.3916 , \\ G n c = ( 1 - r c - b c ) \cdot S c / M \\ = ( {2}^{n} - 1 - 6 - 4 ) / ( {2}^{n} - 1 ) \cdot 5.5915 / 10.3337 \\ = 0.1804 , and \\ B n c = b c \cdot S c / N \\ = 4 / ( {2}^{n} - 1 ) \cdot 5.5915 / 3.1704 \\ = 0.4703 .\end{matrix}$$

The u′v′ chromaticity coordinate Ac(u′, v′) of the chromaticity values Rnc, Gnc and Bnc becomes Ac(u′, v′)=Ac(0.2958, 0.3909) by following the equations (7) and (8). Since the chromaticity coordinate Ac(0.2958, 0.3909) is included in the triangle formed by the apexes Rk, Gk and Bk in FIG. 22, it shows that the external chromaticity coordinate of the point Da is converted to the internal chromaticity coordinate of the point Dac.

Subsequently, the converted chromaticity values Rnc, Gnc and Bnc are converted to the chromaticity values Rk=0.4971, Gk=0.0618 and Bk=0.4407 in the known color system by following the equation (66) by the color system converter 38. The values of the chromaticity values Rk, Gk and Bk on the u′v′ chromaticity coordinate become (u′, v′)=(0.2958, 0.3909) by following the equations (7), (8) and (63). This u′v′ chromaticity coordinate corresponds to that of the point Ac which is the internal chromaticity in FIG. 22. That is, the chromaticity is maintained before and after the conversion between the color systems.

As mentioned above, the image data based on the new principal colors Rn, Gn and Bn can properly be outputted by the conventional image outputting apparatus by converting the image data converting apparatus in this embodiment.

Generally, when the continuous chromaticity data of the image data are converted so as to be the chromaticity difference larger, the quantization noise increases, so that the decolorization or the pseudo-contour will occur. In this embodiment, the chromaticity data, however, are converted on the chromaticity diagram on which the coordinates are uniformly graduated, perceptively. Thus, it is possible to solve the above-mentioned problem such as the decolorization by converting the continuous chromaticity data in a manner so that the difference between the continuous chromaticity data is made smaller than a predetermined standard value. This can be regarded as the perceptive process of the color conversion.

Furthermore, in the second example of the image data converting apparatus, the external chromaticity values in the new color system are converted to the internal chromaticity values in the new color system, at first. Subsequently, the converted internal chromaticity values in the new color system are further converted to the chromaticity values in the known color system by following the equation (66). Thus, the converted chromaticity values are maintained before and after the conversion between the color systems, so that the chromaticity values are not compressed.

The image data converting apparatus in accordance with the present invention can be modified as follows.

In the above-mentioned description, the image data based on the new principal colors Rn, Gn and Bn are converted so as to be reproduced by the conventional television satisfying the conventional NTSC television standard. It, however, is possible to convert the image data based on the new principal colors Rn, Gn and Bn so as to be reproduced by the image outputting apparatus based on the known three principal colors satisfying the conventional PAL television standard, the SECAM television standard, or the like.

Furthermore, the converted image data by the image data converting apparatus in accordance with the present invention can be reproduced by the conventional image outputting apparatus, the conventional image display apparatus such as the CRT (Cathode Ray Tube apparatus), the LCD (Liquid Crystal Display apparatus), the EL (Electroluminescense display apparatus), the PDP (Plasma Display Panel), the FED (Field Emission Display apparatus), the laser light, the LED (Light Emitting Diode), the DLP (Digital Light Processing), the conventional image printing apparatus such as the color printer and the conventional image exposing apparatus.

For converting the image data which can be reproduced by the above-mentioned image data outputting apparatus, it is necessary to modify the above-mentioned equations used in the conversion between the color systems for corresponding to the principal colors in the known color system used in each image data outputting apparatus.

In the above-mentioned description, the image data outputting apparatus is selected among the conventional apparatuses. It, however, is possible to output the converted image data from an image data outputting apparatus based on an optional new color system including the above-mentioned new color systems.

When any one of the image data Rk, Gk and Bk obtained by the conversion process following the equation (66) takes the negative value, it is possible to replace the negative value to “0”. Furthermore, there is an image data standard such as the photo CD (trade mark) standard cooperatively developed by Eastman Kodak Company, and Royal Philips Electronics, in which the negative values of the image data can be treated. Thus, it is possible to record the image data including the negative values in such the recording media.

In the above-mentioned second example of the image data outputting apparatus shown in FIG. 21, it is possible to modify the color system converter 35 so as to have a plurality of converting characteristics corresponding to a plurality of image data outputting apparatuses respectively based on different color systems. The converting characteristic of the color system converter 35 is externally selected by corresponding to the color reproduction characteristic of the image outputting apparatus.

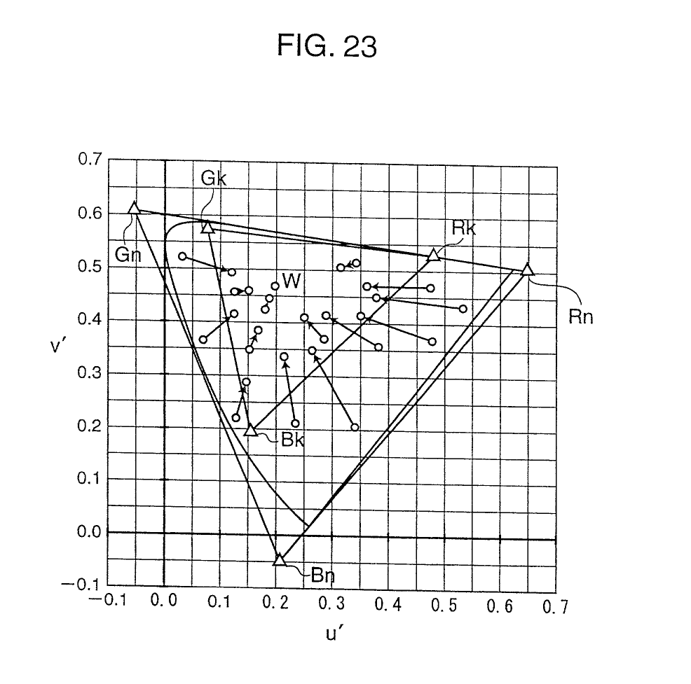

Furthermore, it is possible that the color system converter 35 in FIG. 21 has a converting characteristic shown in FIG. 23. As can be seen from FIG. 23, the chromaticity coordinate of the external chromaticity is converted to that of the internal chromaticity so as not to vary the hue so large. In other words, the chromaticity coordinate of the converted chromaticity is disposed on a line binding the origin and the original chromaticity coordinate before the conversion. Furthermore, the larger the saturation ratio of the chromaticity data becomes, the larger the converted chromaticity data is compressed. In other words, the nearer the chromaticity point is disposed to the standard white W, the smaller the degree of the compression of the chromaticity data becomes. In FIG. 23, the lengths of the arrows designate the degree of the compression of the chromaticity data. The arrow having the longer length shows that the degree of the compression of the chromaticity data is higher. Furthermore, it is possible to select the converting characteristic of the color system converter 35 so as to reproduce an optional color such as a color of human skin to be suitable.

Furthermore, the image data converting apparatus is described for outputting the converted image data to the conventional image outputting apparatus in the above-mentioned description. The present invention is not restricted by the description of the embodiment. It is possible to modify the converting characteristic of the color system converter 35 when only the image data based on the new principal colors Rn, Gn and Bn are necessary. For example, a plurality of color charts having the known chromaticity are prepared, and the chromaticity information of them are obtained by the imaging unit 31. The converting characteristic of the color system converter 35 is selected so as to coincide the chromaticity data obtained by the imaging unit 31 with the known chromaticity.

Furthermore, the color matching function rn(λ) in the new principal colors has responsible portions in the shorter wavelength region and the middle wavelength region as shown, for example, in FIG. 3. When the optical filter corresponding to the responsible portion in the shorter wavelength region is omitted due to the configuration or the cost of the imaging apparatus, the characteristics of the image data taken by the imaging apparatus will be reduced. It, however is possible to prevent the reduction of the characteristics of the image data by modifying the converting characteristic of the color system converter 35.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An imaging apparatus comprising: three kinds of optical filters respectively having different spectral transmittance characteristics; and a photoelectric transfer device for transferring optical images which are formed by color separation of light from an object by the optical filters to electric signals and for outputting predetermined image signals; wherein
the spectral transmittance characteristics of the optical filters respectively correspond to color matching functions based on chromaticity coordinates of three apexes forming a triangle including whole area of visible lights on a UCS chromaticity diagram; and
the chromaticity coordinates of the apexes of the triangle satisfies the following condition that a line binding a first apex and a second apex of the triangle circumscribes at least a part of a spectral locus of the visible lights on the UCS chromaticity diagram, a line binding the second apex and a third apex of the triangle circumscribes at least a part of the spectral locus of the visible lights on the UCS chromaticity diagram, and a line binding the first apex and the third apex of the triangle circumscribes at least a part of the purple boundary on the UCS chromaticity diagram.

2. The imaging apparatus in accordance with claim 1, wherein the UCS chromaticity diagram is the CIE 1976 UCS chromaticity diagram, and the line binding the first apex and the second apex of the triangle satisfies an equation 0.15u′+v′=0.6

3. The imaging apparatus in accordance with claim 2, wherein the triangle is an equilateral triangle.

4. The imaging apparatus in accordance with claim 2, wherein the triangle is an isosceles triangle, and the line binding the first apex and the third apex superimposes on the purple boundary on the UCS chromaticity diagram.

5. The imaging apparatus in accordance with claim 1, wherein the UCS chromaticity diagram is the CIE 1976 UCS chromaticity diagram, and the line binding the first apex and the third apex of the triangle superimposes on the purple boundary of the UCS chromaticity diagram.

6. The imaging apparatus in accordance with claim 1, wherein the UCS chromaticity diagram is the CIE 1960 UCS chromaticity diagram, and the line binding the first apex and the second apex of the triangle satisfies an equation 0.1u+v=0.4.

7. The imaging apparatus in accordance with claim 6, wherein the triangle is an isosceles right triangle, and an interior angle of the third apex is the right angle.

8. The imaging apparatus in accordance with claim 6, wherein the triangle is an isosceles triangle, and the line binding the first apex and the third apex of the triangle superimposes on the purple boundary of the UCS chromaticity diagram.

9. The imaging apparatus in accordance with claim 6, wherein the line binding the first apex and the third apex of the triangle superimposes on the purple boundary of the UCS chromaticity diagram, and an interior angle of the third apex is the right angle.

10. The imaging apparatus in accordance with claim 1, wherein the UCS chromaticity diagram is the CIE 1960 UCS chromaticity diagram, and the line binding the first apex and the third apex of the triangle superimposes on the purple boundary of the UCS chromaticity diagram.

11. A set of optical filters comprising: first optical filters having a characteristic corresponding to a color matching function based on a chromaticity coordinate of a first apex of a triangle including whole area of visible lights on a UCS chromaticity diagram; second optical filters having a characteristic corresponding to a color matching function based on a chromaticity coordinate of a second apex of the triangle; and third optical filters having a characteristic corresponding to a color matching function based on a chromaticity coordinate of a third apex of the triangle; wherein
the chromaticity coordinates of the apexes of the triangle satisfies the following condition that a line binding a first apex and a second apex of the triangle circumscribes at least a part of a spectral locus of the visible lights on the UCS chromaticity diagram, a line binding the second apex and a third apex of the triangle circumscribes at least a part of the spectral locus of the visible lights on the UCS chromaticity diagram, and a line binding the first apex and the third apex of the triangle circumscribes at least a part of the purple boundary on the UCS chromaticity diagram.

12. An image data converting apparatus comprising: three kinds of optical filters respectively having different spectral transmittance characteristics; a photoelectric transfer device for transferring optical images which are formed by color separation of light from an object by the optical filters to electric signals and for outputting predetermined image signals; and a color system converter for converting three kinds of image signals outputted from the photoelectric transfer device to other image signals in another color system based on predetermined three principal colors; wherein
the spectral transmittance characteristics of the optical filters respectively correspond to color matching functions based on chromaticity coordinates of three apexes forming a triangle including whole area of visible lights on a UCS chromaticity diagram; and
the chromaticity coordinates of the apexes of the triangle satisfies the following condition that a line binding a first apex and a second apex of the triangle circumscribes at least a part of a spectral locus of the visible lights on the UCS chromaticity diagram, a line binding the second apex and a third apex of the triangle circumscribes at least a part of the spectral locus of the visible lights on the UCS chromaticity diagram, and a line binding the first apex and the third apex of the triangle circumscribes at least a part of the purple boundary on the UCS chromaticity diagram; and
the color system converter converts chromaticity coordinates of the three kinds of the image signals to chromaticity coordinates in an area of color reproduction in the color system based on the predetermined three principal colors on the UCS chromaticity diagram.

13. The image data converting apparatus in accordance with claim 12, wherein the color system converter generates three kinds of compensated image signals by processing predetermined image process to the three kinds of image signals outputted from the photoelectric transfer device, and converts the chromaticity coordinates of the compensated image signals to other chromaticity coordinates in the area of color reproduction.
